(19) United States
(12) Patent Application Publication
(10) Pub. No.: US 2026/0110793 A1
(43) Pub. Date: Apr. 23, 2026

(54) RADAR-BASED YIELD MONITORING AND GRAIN QUALITY MEASUREMENT SYSTEM

(71) Applicant: Bitstrata Systems Inc., Saskatoon (CA)

(72) Inventors: Ian Robert Meier, Saskatoon (CA); Michael David Lockerbie, Saskatoon (CA)

(73) Assignee: Bitstrata Systems Inc., Saskatoon, SK (CA)

(21) Appl. No.: 19/118,153

(22) PCT Filed: Oct. 5, 2023
(86) PCT No.: PCT/CA2023/051318

§ 371 Date: Apr. 3, 2025

Related U.S. Application Data
(60) Provisional application No. 63/413,378, filed on Oct. 5, 2022.
(60) Provisional application No. 63/445,878, filed on Feb. 15, 2023.

(51) Int. Cl. G01S 13/89; A01D 41/127; G01K 5/48; G01L 3/04; G01N 22/04; G01S 13/58

(52) U.S. Cl. CPC G01S 13/89; A01D 41/127; G01K 5/48; G01L 3/04; G01N 22/04; G01S 13/583

(57) ABSTRACT

A system or method for using a Frequency-Modulated Continuous Wave (FMCW) radar system installed on a harvester for determining yield data, the system or method comprising locating the FMCW radar system on the exterior of a clean grain elevator housing in a fixed location such that a signal may be transmitted into the housing. The signal may be guided by a waveguide and reflected off a surface of a load or the one or more components where the distance to the load or the one or more components is related to one or more properties of the load. The FMCW radar system is configured to use the reflected signal to determine the one or more properties of the load.

### CROSS REFERENCE TO RELATED APPLICATIONS

This application claims the benefit of the filing date under 35 U.S.C. § 119(e) of U.S. Provisional Application Ser. No. 63/413,378 filed on Oct. 5, 2022, and U.S. Provisional Application Ser. No. 63/445,878 filed on Feb. 15, 2023, the entire disclosures of which are incorporated by reference in their entirety.

### BACKGROUND

Measurements of grain properties, including weight, moisture, bulk density, volume, and temperature are useful in the management of a grain operation. For example, real-time weight measurements allow a farm manager to track production and assess field performance. Accurate inventory tracking facilitates executing on market opportunities, while monitoring performance facilitates optimization of yields and profits. Moisture measurement enables a farm manager to manage the safe storage and harvesting of crop, avoiding spoilage. Additionally, bulk density (test weight) is a measure of grain quality and knowledge of this allows for more accurate assessment of volumetric bin utilization.

There are many farm tools used to monitor grain properties, each suffering trade-offs including spatial or temporal resolution, measurement location, accuracy, convenience, etc. One of the most popular and pervasively used in grain farming is the yield monitor, which has become standard equipment in most modern combine harvesters.

A grain yield monitor is a device that measures the amount of grain produced per spatial location of a field. With this data, a geospatial measurement of yield (yield map) may be generated that represents the yield geospatially throughout the field. This information may provide insight as to the performance of a field at various locations and is the input to the next season's precision farming program.

If W_{grain} is the weight of grain harvested from given area, A, the yield for this area is as follows:

$$yield = \frac{{W}_{grain}}{A}$$

If w_{swath} is the swath width of the harvested grain, s_{combine} is the speed of the combine harvester, and Δt is the time over which the area is traversed, the area may be determined as follows:

$$A = {w}_{swath} {s}_{combine} Δ t$$

Accurate and precise (spatial and temporal) measurement of combine speed is needed for accurate area determination. Satellite-based positioning systems are widely used with high accuracy, and this accuracy and resolution may be improved further by supplementing with terrestrial-based real-time kinematics.

An alternative to satellite-based solutions is ground-speed radar, which may provide accurate and precise measurements at high update rates without reliance on external satellite or ground-based equipment or services. Such systems use the reflection from the ground and the Doppler shift of the signal. Applications may be best served using a combination of the two technologies.

Combine harvesters typically use mass-flow or volumetric sensing to measure the weight of harvested clean grain, as bulk mass measurement systems may not be practical in typical harvester designs as the storage hopper may not be easily suspended by load cells. After the combine has removed the straw and chaff, the grain is transported to the hopper tank via the clean grain elevator. The clean grain elevator operates by scooping threshed and cleaned grain with paddles 110 mounted to a sprocket-driven chain, elevating then throwing each paddle load into an auger which conveys the cleaned grain to a storage hopper before returning below to repeat the process. On a typical combine harvester, the elevator is fed clean grain via an auger that is laterally mounted and drives the lower sprocket. Because the clean grain elevator transports the threshed and cleaned grain to the storage hopper, it is a convenient location for yield sensors.

Typical grain mass-flow sensors utilize either a force plate onto which grain is thrown as it exits the elevator before being conveyed to the hopper tank, or an electric eye positioned across the elevator housing that measures the beam's duty cycle, indicating the height of grain piled on each elevator paddle as it passes by.

Force plate systems redirect the trajectory of grain as it is thrown from the elevator and monitor the reactionary force. Individual kernels impacting the sensor contribute impulses to the signal, which builds to a noisy aggregate estimate of the grain weight. Inaccuracies are inherent as a kernel's location within the grain pile affects its contribution to the signal. This is due to both the variable kinetic energy developed for the kernel based on distance from the elevator chain, as well as the location at which the kernel impacts the force plate, which may not be uniformly sensitive across its surface. Further, low energy kernels may miss the plate entirely. The speed of the clean grain elevator may also be considered as it affects the grain's kinetic energy. Mass flow sensors based on force plates also typically require independent calibration for each crop type, and material may build up on the plate, impairing the measurement accuracy.

Electric eye systems measure the height of each grain pile by assuming a shape to estimate the volume and, in turn, the mass or weight of grain on the paddle. The volume estimate may be converted to mass/weight using an assumed or measured density for that grain. These assumptions may lead to inaccurate mass measurement as they may not accurately represent the actual grain being elevated.

These conventional yield monitor designs may result in poor yield map quality due to measurement and/or calibration inaccuracies. Further, as recalibration is frequently required due to changing conditions (speeds, crop types, etc.), this inconvenience may result in foregoing sensor calibration, instead relying on either post-calibrating the yield maps after harvest or abandoning their use entirely. In either case, the utility for precision farming is degraded. The problem is exacerbated when multiple combine harvesters are used in the same field, each with its own independently and differently calibrated yield monitor.

### BRIEF SUMMARY

Embodiments provide a system for determining yield data for a grain operation, the system comprising: a Frequency-Modulated Continuous Wave (FMCW) radar system configured to generate and transmit a signal and one or more components of a clean grain elevator configured to carry a load; wherein the FMCW radar system is configured to measure a distance from the FMCW radar system to the one or more components using the signal, wherein the distance to the one or more components varies with a weight of the load carried or handled by the one or more components.

Embodiments provide a method for determining yield data for a grain operation, the method comprising: generating and transmitting, by a Frequency-Modulated Continuous Wave (FMCW) radar system, a signal; coupling the signal into a waveguide affixed to a paddle attached to a moving paddle chain; reflecting the signal off a surface attached to the paddle, wherein a distance from the FMCW radar system to the surface varied depending on a weight of material carried by the paddle; and determining, by the FMCW radar system, the weight of the material carried by the paddle using a frequency or a phase of the reflected signal.

Embodiments provide a waveguide system for determining yield data for a grain operation, the waveguide system comprising: a single main waveguide tube comprising one or more auxiliary waveguide tap points that are configured to guide a signal from a Frequency-Modulated Continuous Wave (FMCW) radar system to one or more components of a clean grain elevator and return a reflected signal to the Frequency-Modulated Continuous Wave (FMCW) radar system that is configured to determine one or more data points for grain carried by the clean grain elevator.

### BRIEF DESCRIPTION OF THE DRAWINGS

FIG. 1 depicts a single radar feeding a waveguide with multiple apertures according to an embodiment.

FIG. 2 depicts a close-up view of a double beam configuration according to an embodiment.

FIG. 3 depicts an embodiment of an FMCW radar system integrated into the clean grain elevator to measure the volume of each pile of grain on a paddle.

FIG. 4 depicts an FMCW radar on the left side situated to measure the distance to the underside of each laden paddle according to an embodiment.

FIG. 5 depicts an example shaft and arrangement for measuring rotational power thereof according to one embodiment.

FIG. 6 depicts an example sprocket/pully and arrangement for measuring rotational power thereof according to one embodiment.

FIG. 7 depicts an embodiment that enables measuring linear or rotational displacement with a single point of measurement.

FIG. 8 depicts embodiments for determining the moisture content and bulk density as well as volume and grain pile shape.

FIG. 9 depicts an example low profile form factor of a deflecting member according to an embodiment.

FIG. 10 depicts an example rigid plate according to an embodiment.

FIG. 11 depicts a flexible layer for the rigid plate of FIG. 10 according to an embodiment.

FIG. 12 depicts an example of a coiled waveguide according to an embodiment.

FIG. 13 depicts an example mounting plate according to an embodiment.

FIG. 14 depicts the mounting plate of FIG. 13 connected to a paddle chain according to an embodiment.

FIG. 15 depicts another example of the mounting plate of FIG. 13 connected to a paddle chain according to an embodiment.

FIG. 16 depicts an example of a laminated assembly according to an embodiment.

FIG. 17 depicts another example of an assembly connected to a paddle chain according to an embodiment.

FIG. 18 depicts a view from the bottom of a paddle-based yield monitor scale design according to an embodiment.

FIG. 19 depicts an example of a second reflector on the bottom of a paddle-based yield monitor scale design according to an embodiment.

FIG. 20 depicts a side view of a paddle-based yield monitor scale design according to an embodiment.

FIG. 21 depicts a side view of a paddle-based yield monitor scale design according to an embodiment.

FIGS. 22A, 22B, and 22C depict example sensors according to an embodiment.

FIG. 23 depicts a hemispherical hollow chamber according to an embodiment.

FIG. 24 depicts a sensor with three phase shifts defined according to an embodiment.

FIGS. 25A, 25B, and 25C depict example waveguides according to an embodiment.

FIG. 26 depicts an example of a graph for a phase line according to an embodiment.

FIG. 27 depicts a graph for where two phases are received according to an embodiment.

FIG. 28 depicts a graph for example signals according to an embodiment.

FIG. 29 depicts a graph for example signals according to an embodiment.

### DETAILED DESCRIPTION

The embodiments disclosed herein describe a mass-flow sensing system for measuring harvested clean grain independent of crop type, grain pile shape, and grain test weight (density), dramatically improving yield map quality, simplifying, and thus advancing the adoption and use of precision farming practices. The described embodiments disclose instrumentation of the clean grain elevator, but these techniques may also be used in any bucket elevator or conveyor system, such as a harvester's tailings return elevator as a mechanism for measuring the amount of grain and material being re-threshed or measuring the quantity of bulk material conveyance in general.

Embodiments provide a weight sensor in each paddle of the clean grain elevator that measures the weight of each grain pile in transit. Like electric eye designs, embodiments make measurements discretely on a per-paddle basis. However, unlike conventional approaches embodiments make absolute weight measurements for much improved weight data quality.

Embodiments provide wireless energy harvesting techniques that are used to power the sensor and electronics attached or integrated with each paddle, and wireless communications to backhaul/communicate the data. Energy may be harvested from the movement of the chain. An abrupt step change in direction and velocity is experienced at the points where the chain enters and exits the top and bottom sprockets of the elevator. Some of this energy may be captured, such as by a resonant mechanical tine embedded in the paddle or its mount and converted to and stored as electricity using, for example, a transducer, rectifier, and storage capacitor.

Embodiments eliminate the need of active sensing, processing, or communication electronics on the moving parts of the elevator. Instead, embodiments employ remote-sensing based on a Frequency-Modulated Continuous Wave (FMCW) radar system located away from the moving parts that monitors passive mechanical radar-compatible elements designed into the chain, paddle-mount, and/or paddle that are responsive to the weight of material the chain, paddle-mount, and/or paddle carry, as described below. The FMCW radar precisely measures a distance to the remote weight-sensitive mechanical elements, the positions of which (distance to the radar device) change with weight.

FMCW radar is a technology that allows for the remote detection of the position of an object. As it is a radio-based technology, FMCW radar has many advantages over other sensing technologies that may be impaired by environmental conditions, such as optical/vision-based systems, which may be impaired, for example, by dust, fog, rain, etc. and ultrasound-based systems, which may be impaired, for example, by dust and wind. By operating in the millimeter wavelength region, the radar's antenna geometries become miniaturized, allowing for very small-scale antenna arrays. This results in an extremely robust and compact sensing device, able to detect the location and speed of objects in its surroundings. Millimeter wave (mmWave) is a class of radar technology that uses short wavelength electromagnetic waves. Radar works by transmitting electromagnetic wave signals that objects in the signal's path then reflect. By capturing the reflected signal, a radar system can determine the range, velocity, and angle of the objects.

An FMCW radar device operates by wirelessly transmitting a chirp signal, which starts at one frequency and linearly ramps to another, higher or lower frequency, and repeats. Any portion of the signal reflected off an object back toward a receiver antenna is then mixed, or multiplied with the transmitted signal, which generates an intermediate frequency (I/F) signal. The frequency of the I/F signal is equal to the difference in frequency between the transmitted and received signals, that is proportional to the amount of time the transmit chirp was active before the reflected signal was received. This time is equal to the signal's propagation delay from the transmit antenna to the object plus the propagation delay from the object to the receive antenna. Because the signal travels at the speed of light, the distance between the radar antennas and the object can be determined or otherwise derived by multiplying the average of these two propagation delay times by the speed of light.

In FMCW systems, the positions of objects within the radar's field-of-view may be determined using reflections of the transmitted signal. Using the delay in time of a reflected signal and the speed of radio wave propagation, precise locations of objects may be determined. However, location is not the only measurement that may be determined using an FMCW radar, and the sections that follow describe embodiments that allow determination of various parameters of grain or other crops.

Free space losses result from signals radiating isotropically outward so that a remote detector sees increasingly smaller portions of the energy as distance increases. Waveguides are passive elements (tubes) used to guide electromagnetic waves along a desired path, constraining their energy to avoid the free space losses experienced with isotropic or other non-constrained radiation patterns. Waveguides are analogous to conductive transmission lines used commonly at lower frequencies but may result in much lower losses and signal degradation. It may be important to consider the method of coupling and any related impedance mismatches that may be introduced at the endpoints of a waveguide.

Each FMCW device may be packaged as a discrete sensor connected to power and data communications with one or more cables, such as controller area network (CAN), so that it can be easily located and oriented for optimum performance. Multiple sensor devices may then connect to a single computing module, for data capture and analysis, machine control, and data backhaul such as via wired and Wi-Fi, Ethernet, Cellular, satellite or point-to-point wireless communications. Each of the FMCW devices may include multiple components such as transmit (TX) and receive (RX) radio frequency (RF) components e.g., antennas; analog components such as clocking; and digital components such as analog-to-digital converters (ADCs), microcontrollers (MCUs) and digital signal processors (DSPs) among other components. In an embodiment, multiple FMCW devices are in communication with a computing module that directs the FMCW devices and analyzes the results.

The computing module may be configured to process and analysis data from each of the FMCW radar modules and in this way, provide information about the yield to an operator or centralized location using, for example, a standard wired or wireless network. The computing module may further be configured to communicate with other remote computing modules on other pieces of equipment or objects using the FMCW radar signals generated and received by the radar modules thus allowing operators to understand the operation and orientation of multiple objects or pieces of equipment in the field. The computing module may include different modules, units, or components such as a processing unit and a memory.

The processing unit may be configured to process signals from the radar modules. The processing unit may be or include a central processing unit (CPU), a graphics processing unit (GPU), or both. The processing unit may be a component in a variety of systems. For example, the processing unit may be part of a standard personal computer or a workstation. The processing unit may be one or more general processors, digital signal processors, specifically configured processors, application specific integrated circuits, field programmable gate arrays, servers, networks, digital circuits, analog circuits, combinations thereof, or other now known or later developed devices for analyzing and processing data. The processing unit may implement a software program, such as code generated manually or automatically (i.e., programmed).

The processing unit may include a memory that can communicate via a bus. The memory may be a main memory, a static memory, or a dynamic memory. The memory may include, but is not limited to, computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory includes a cache or random-access memory for the processing unit. In alternative embodiments, the memory is separate from the processing unit, such as a cache memory of a processor, the system memory, or other memory. The memory may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory is operable to store instructions executable by the processing unit. The functions, acts or tasks illustrated in the figures or described herein may be performed by the programmed processing unit executing the instructions stored in the memory. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

The processing unit may further include a display unit, such as a liquid crystal display (LCD), an organic light emitting diode (OLED), a flat panel display, a solid-state display, a cathode ray tube (CRT), a projector, a printer or other now known or later developed display device for outputting determined information. The display may act as an interface for the user to see the functioning of the processing unit, or specifically as an interface with the software stored in the memory.

Additionally, the processing unit may include an input device configured to allow a user to interact with. The input device may be a number pad, a keyboard, or a cursor control device, such as a mouse, or a joystick, touch screen display, remote control, or any other device.

The processing unit may also include a disk or optical drive unit. The disk drive unit may include a computer-readable medium in which one or more sets of instructions, e.g., software, can be embedded. Further, the instructions may embody one or more of the methods or logic as described herein. In a particular embodiment, the instructions may reside completely, or at least partially, within the memory and/or within the processing unit. The memory and the processing unit also may include computer-readable media as discussed herein.

The present disclosure contemplates a computer-readable medium that includes instructions or receives and executes instructions responsive to a propagated signal, so that a device connected to a network can communicate voice, video, audio, images, or any other data over the network. Further, the instructions may be transmitted or received over the network via a communication interface. The communication interface may be a part of the processing unit or may be a separate component. The communication interface may be created in software or may be a physical connection in hardware. The communication interface is configured to connect with a network, external media, the display, or any other components, or combinations thereof. The connection with the network may be a physical connection, such as a wired Ethernet connection or may be established wirelessly. Likewise, the additional connections with other components of the system may be physical connections or may be established wirelessly.

The network may include wired networks, wireless networks, or combinations thereof. The wireless network may be a cellular telephone network, an 802.11, 802.16, 802.20, or WiMAX network. Further, the network may be a public network, such as the Internet, a private network, such as an intranet, or combinations thereof, and may utilize a variety of networking protocols now available or later developed including, but not limited to, TCP/IP based networking protocols.

In an embodiment, the FMCW radar device is located away from the moving parts of the elevator and configured to couple signals into an open end of a waveguide attached to the paddle, and which, in some implementations, in the same plane thereof. If the radar device is located outside the elevator housing, a coupling port (hole) may be used for signal ingress and egress. The paddle with integrated waveguide may be supported by the chain through, for example, a double bending beam arrangement, e.g., using two or more bending beams coupled with one or more rigid elements to enforce a substantially vertical shift of the load application point and an S-shaped deformation of the beams that deflects with weight (downward as weight increases) while maintaining the original attitude of the paddle as to not interfere with the grain transport operation and improving weighing linearity. Paddle waveguides may be aligned to share the coupling port as the paddle waveguides each pass the radar. Other weight sensing and waveguide configurations may be possible.

As individual paddles arrive at the radar coupling location, the transmit signal couples into the integrated waveguide and travel to a point along the length of the waveguide where the transmit signal radiates through an aperture aimed down toward the double bending beam's upper surface, which deflects with applied load. The aperture may be cantilevered over the beam so that the distance from the radar to the upper face of the beam changes based on the applied weight. The signal then reflects off the beam, re-enters the aperture, and returns to the radar device through the waveguide, allowing the radar to precisely measure the distance. Hooke's Law may then be applied to convert this displacement to a weight. The system may be configured to protect the waveguide component from applied weight so that the integrity of the waveguide and resulting measurement accuracy are preserved.

In an embodiment, a second waveguide is employed and positioned underneath the paddle, with an aperture of the second waveguide pointed up to toward the lower face of the double bending beam 140. Because the distance between the aperture increases with applied weight, and the distance between the aperture of the upper waveguide decreases with applied weight, using both measurements allow for a differential measurement, minimizing offset drifts due to thermal effects and improving the signal to noise ratio.

The internal environment of a clean grain elevator in operation may be dusty and may have grain kernels in constant motion. As such, sensitive electronic equipment and waveguides may be sealed to prevent dust or debris from infiltration. It is important that waveguides remain clean to prevent performance degradation, and waveguides may be vacuum sealed for at least this reason. The sealing membrane may be implemented such that radar signals pass unimpeded or in a deterministic way that may be modelled. Some materials suitable as a covering may include glass, plastic, or mica. The material may be chosen for sufficient durability while maintaining stable dielectric properties.

In other embodiments, multiple radar devices may be provided to increase the number of measurements made of a given paddle to improve data quality through averaging or other techniques. Other embodiments may use a single radar feeding a waveguide with multiple apertures to perform a similar function while reducing cost and/or complexity.

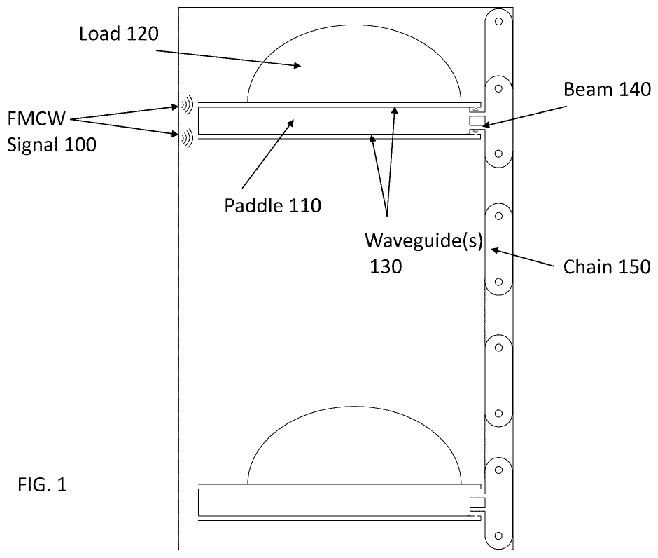

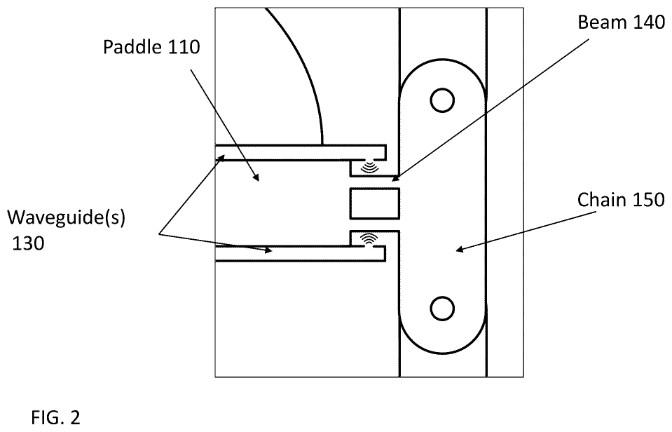

FIG. 1 depicts a single radar signal 100 from an FMCW radar system feeding a waveguide 130 with multiple apertures along with an embodiment of a paddle 110 for use with a clean-grain elevator as described. The paddle 110, shown in side-view with integrated waveguides 130 above and below, is mounted to a chain link via two metal bars, which form the double bending beam 140. The waveguide(s) may be any a structure that guides waves by restricting the transmission of energy to one direction. The double beam configuration is used to enforce a vertical shift of the paddle 110 in response to the load 120 (grain). FIG. 2 depicts a close-up view of this.

As the beams 140 deform under load 120, the measured distance to each beam 140 face changes with applied weight of the load 120. In this configuration, it may be seen that the polarity of the distance measurements will be opposite each other, allowing for differential measurement as described earlier. The point along the bending beam 140 where the radar signal is aimed affects the gain of the system, with increased gain closer to the chain link. The double bending beam 140 embodiment disclosed may also be used to measure weights in general, such as between a vehicle frame and wheel, a weighing platform and support, etc.

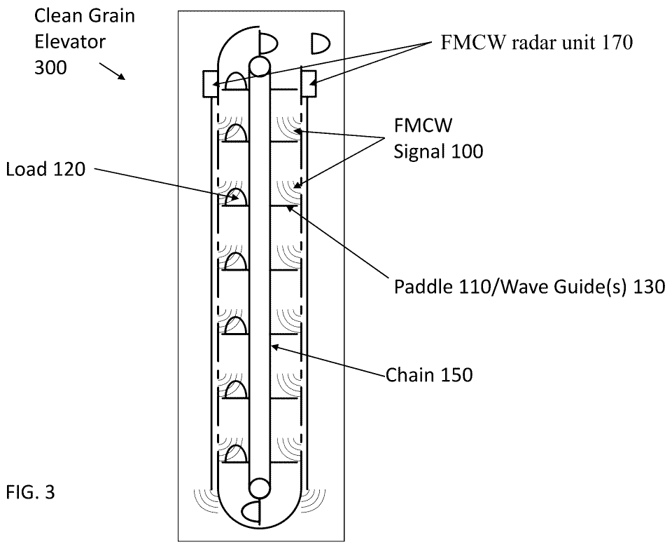

FIG. 3 depicts an embodiment of an FMCW radar system integrated into the clean grain elevator 300 to measure the volume of each pile of grain (load 120) on a paddle 110.

In FIG. 3, the elevator paddles 110 run clockwise, rising on the left and falling on the right. The grain piles 120 exit the elevator 300 at the top-right. The rectangular shapes near the top represent FMCW radar units 170 attached to downward-facing waveguides 130. The waveguides 130 include λ/4 directional couplers that direct a portion of the signal into the elevator housing at multiple points and prescribed radiation patterns/directions in cascading fashion. This allows the FMCW radar units 170 to measure the distance to each paddle 110 as the paddles 110 traverse the system 300, revealing the pile shape through measurements from multiple perspectives. The volume of grain may be inferred by fitting a mathematical model to the observations, including but not limited to cones, pyramids, truncated cones, or pyramids, etc.

The direction couplers may be realized using a series of two or more holes where the distance between holes is given as:

$$d = n * \frac{λ}{2} + \frac{λ}{4}$$

Due to the nature of grain elevator 300, the holes may need to be sealed such that grain kernels or dust do not lodge in the waveguide 130 itself while allowing the radar signals to pass unimpeded or affected in a known manner. Covering/sealing materials may include glass, plastic, or mica, and may provide sufficient strength for durability. Though radar signals may pass through dust with minimal signal degradation, blowers, fans, or brushes may be used to maintain the cleanliness of the dust-covering components. Because the paddles 110 move through the elevator, brushes may be installed in one or more fixed locations on the inside walls of the elevator housing such that the dust covers requiring cleaning pass by each brush for every elevator cycle.

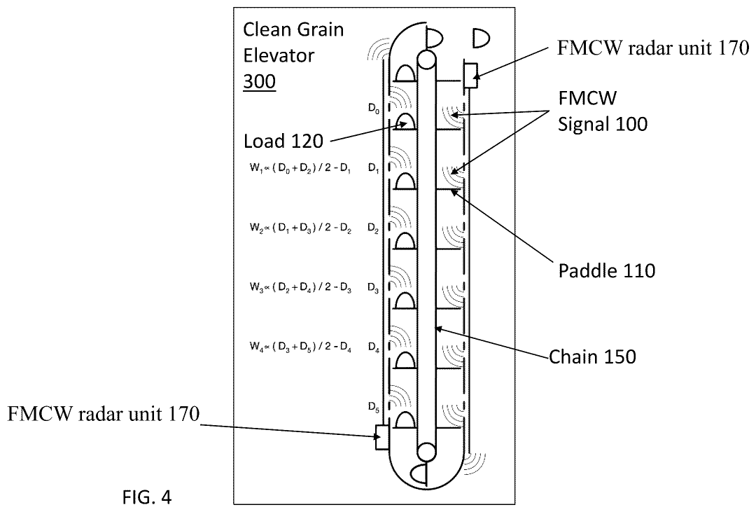

FIG. 4 depicts the FMCW radar situated to measure the distance to the underside of each laden paddle 110. As the weight carried by the paddles 110 increases, the paddle chain 150 stretches, and the distance measurement may be used to measure weight carried by a section of the paddle chain 150. This provides a consistent reflection surface for determination of weight, avoiding the variable distances due to variable grain pile size/shape.

As shown in FIG. 4, the weight carried by a paddle 110 may be determined by the difference between the position of the paddle 110 of interest and the midpoint between its two immediate neighbors. The midpoint of the adjacent paddles 110 is used as a reference datum from which distances of the paddle 110 of interest may be used to measure the weight.

The torque and/or rotational speed (rpm) of a shaft (not shown) driving, for example, the elevator 300 or other conveyor, or other driven mechanism of a machine, such as the conveyor/elevator 300 shown in FIG. 4, may be measured and the measurements multiplied together to determine the mechanical rotational power delivered by the shaft to, for example, determine the mass flow rate through the conveyor, as the mass flow rate through a conveyor is proportional to the power required to drive the conveyor. This may be utilized, for example, on a bucket conveyor, belt conveyor, screw conveyor/auger, or other type of conveyor now available or later developed, etc. When used to measure the rotational power delivered to the clean grain elevator 300 or to the combine tank loading auger, the power measurement is proportional to the grain flow rate, which is proportional to the instantaneous crop yield. The power measurement may also be used to measure the grain flow rate and/or total grain transferred (the time integral of the flow rate) through, for example, an unloading auger on a combine, seed tender, or grain cart, a fill auger on a seed tender or seed drill, or a transfer auger, transport auger, swing-away auger, or grain belt.

The rotational power may also be utilized to monitor various aspects of the performance of a harvester, such as a combine or forage harvester. A combine harvester operates primarily via rotational power, where the crop is cut by the combine head/header, travels up through the feeder house to the feed accelerator, then to the rotor where it is threshed. The grain is then separated and cleaned with a set of sieves, and the straw is fed through the back of the combine and chopped into smaller pieces by a straw chopper. Each of these rotating sub-assemblies represent an opportunity for the machine to become plugged/obstructed by material, requiring the machine to stop. Such incidents result in lost harvesting time, difficult/hazardous manual labor for clearing the obstruction, and disruptions to logistics. By measuring the instantaneous rotational power of each of these components, imminent plugging/obstruction may be detected via the increased mechanical load and resultant excessive operating power requirements, and the forward motion of the machine reduced or stopped to allow material to pass through the machine before plugging occurs.

The FMCW radar system described herein may be used to measure the torque and rotational speed of a shaft 1402 by utilizing two or more sections 1404 with steps 1406 around the perimeter, similar to a sprocket as will be described.

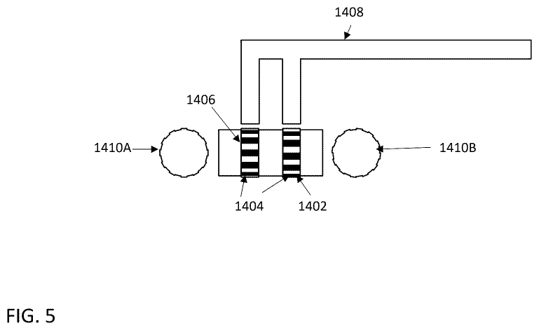

FIG. 5 illustrates an embodiment of a shaft 1402, for use with, i.e., to drive, a grain elevator, such as that shown in FIGS. 3-4, for example, with two of these sections 1404 with a waveguide 1408 positioned above to measure the phase of each reflected signals, as well as end views 1410A and 1410B of the shaft 1402 from each side illustrating the sprocket-like profile. The sections 1404 may have a weakened portion of the shaft 1402 between them or may be spread apart such that there is enough twist in the shaft 1402 as result of the applied torque to cause a relative rotation between the stepped sections. The steps 1406 are shown with a relative angular offset shift of 90 degrees of the step pitch, allowing the detection of both the rotational speed and direction, as one set of steps 1406 will lead the other in time based on the direction of rotation. The steps 1406 may be fabricated with a height of ⅛ of a wavelength of the radar signal, so that the round-trip reflected signal is phase-shifted by a maximum difference of ¼ of a wavelength between the raised and lowered portions of the steps 1406. Then, as the step 1406 passes by the waveguide 1408 aperture, the effective shift is a weighted average of the phase between the raised and lowered portions. If the baseline phase is assumed to be based on the waveguide 1408 being aligned with the raised portion, then as the lower portion comes into view, the phase will begin to lag with respect to the baseline. As more of the lower portion comes into view, the phase will lag further until the aperture is entirely aligned with the lower portion and the phase will be lagged by 90 degrees, assuming a ⅛ wavelength step height. Different step 1406 heights will result in different phase shifts. Then as the step 1406 comes back into view of the aperture with further motion, the phase will begin to return to the baseline. This behavior allows for precise knowledge of the angular position of the shaft 1402, and the difference in the angular position as measured at each of the stepped sections 1404 of the shaft 1402 may be used to determine the instantaneous torque if the tortional spring constant of the shaft 1402 is known. The frequency of the angular position can also be used to determine the angular velocity of the shaft 1402 (rpm), and the product of these two measurements may be used to measure the instantaneous power.

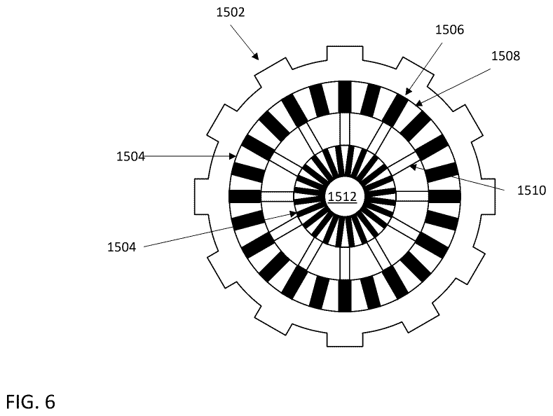

It may also be possible to design a sprocket or pulley that incorporates this concept, such as the sprocket shown in FIG. 6.

FIG. 6 shows an example of a sprocket 1502 with two concentric rings 1504 of radially oriented steps 1506 and valleys 1508 illustrated as black and white bars. The rings 1504 are separated by mechanical elements 1510 arranged to allow rotational displacement between the center 1512 of the sprocket 1502 where the shaft (not shown) would attach, and the outside of the sprocket where the teeth connect to a chain, toothed belt, etc. In the case of a pulley, the teeth would be replaced by a groove where a belt would fit. The flexing mechanical elements 1510 could be constructed as fingers/spokes, as a thin flat disc plate that concentrates the rotational stresses, or by other methods. The concentric rings 1504 may be arranged in an analogous way to the previous shaft example shown in FIG. 5 and described above, just with a different axis of rotation. The waveguide's apertures (not shown) would be located above each ring 1504 and operate in the same manner as described in the shaft example described above. Similarly, the torque, rotational velocity, direction of travel, and rotational power measurements would operate in the same manner as in the shaft example described above.

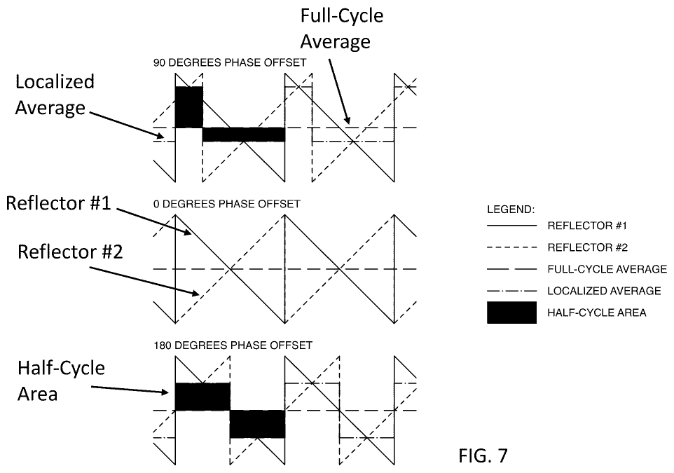

FIG. 7 depicts another embodiment of the FMCW system that enables measuring linear or rotational displacement with a single point of measurement. Arranging a pair of linear sawblade shaped reflectors on a moving element, such as a paddle of a grain elevator, and reference location, such as the chain or mounting plate fastened thereto, similar to the blade of a rip-blade handsaw, each having a sequence of identical ramps (teeth) and oriented adjacently to the other blade but in opposing directions allows an FMCW wave, directed at an arbitrary position along a tooth, to measure the average distance to the reflector pair. These linear shaped reflectors may also be used in implementations where a larger linear displacement is expected or in larger load cells. When teeth are aligned (zero degree phase offset), the average distance is constant everywhere along the length of a tooth-generally one ramp is high when the other is low; however when misaligned, the average distance seen at various positions along a tooth follows the shape of a pulse wave with two distinct sections of constant (but different) average distance and a duty cycle such that the full cycle average is unchanged over all tooth alignment phases; that is: the high half-cycle area (width multiplied by the difference between high half-cycle distance and full cycle average) equals that of the low half-cycle.

Arranging the two linear sawblade reflectors in this manner, each attached to separate fixed or moving elements, such as the chain or mounting plate fastened thereto and the paddle(s) 120 of a grain elevator, allows determination of the relative displacement. By selecting a nominal phase offset (for illustrative purposes 90 degrees) a pulse wave shape of average distance measurements is created with 25% duty cycle for the nominal state. A high precision determination of relative displacement from nominal may be obtained as the change of measured average distance to the blade pair anywhere within the low half-cycle all multiplied by a gain relating to the slope of the reflector tooth.

Rotational displacements useful in torque measurements may be determined with the same technique using rotational reflectors shaped akin to the blade of a circular ripsaw, which, as described herein, might be affixed to rotating elements of the grain elevator, e.g., one or more of the drive or driven shafts or other component of the drive train or a dedicated component coupled therewith. Each adjacent yet reversed phase reflector blade is attached to a common shaft a distance away from its counterpart to provide a length of shaft that will experience twist under torque; further, this length may be weakened to amplify the rotational displacement. To facilitate a single point of measurement despite this physical separation along the shaft, the reflector apparatus may be designed such that its teeth are cantilevered toward those of its counterpart thus bringing the teeth of both reflectors toward the measurement point. Where it is impractical to locate the teeth of the blade pair adjacently, the teeth may remain separated and the FMCW signal may be directed separately to the two sawblade shaped reflectors by means of a waveguide with multiple viewing ports such as depicted in FIG. 5 such that the pulse wave of, for example, FIG. 7 may be computed as the mathematical average of the instantaneous distance measurement to each reflector. The use of sawblade shaped reflector teeth (as described) allows the information of interest to reside only in the AC portion of the summed signal (the pulse wave) so that fixed offsets due to manufacturing and installation variations and/or slow-moving offsets due to temperature or other effects may be ignored as these impact only the DC level on which the pulse wave rides. This property facilitates torque measurement with increased shaft length between reflector pairs for increased sensitivity, lessening the need to weaken the shaft, and may simplify retrofit applications on existing equipment. Retrofit examples may include the laterally mounted auger that drives and feeds the clean grain elevator by adding such a reflector to each end of the auger shaft, thus providing high sensitivity while avoiding interference with mechanical functions. Rotational displacement may be determined as the difference between full-cycle and low half-cycle distance averages multiplied by a gain relating to the slope of the sawtooth reflector. As discussed, the full cycle average does not change with displacement and may be averaged over a long period of time to ensure high precision and low noise. Alternatively, the high half-cycle average may be used in the process instead of the low half-cycle with minor additional computation.

It will be appreciated that the above-described system for measuring rotational power may be implemented at any point along a drive train which drives a driven mechanism, e.g., elevator, conveyor or auger. For example, the above describe system may be deployed to measure rotational power of the power take-off (PTO) shaft of a tractor or output shaft of another motor used to drive the mechanism which is to be characterized by the measured rotational power as described. The rotational power may be measured from, for example, the PTO shaft itself or the coupling which connects, for example, the gain cart or auger thereto. In one embodiment, the disclosed mechanism may be integrated into a geared or hydraulic transmission used to control the operation of a power take off shaft or other drive mechanism, or otherwise used to control the delivery of driving force to the driven mechanism.

Along with the mass of the grain, the measurement of yield requires the speed of the combine. FMCW radar may be used to provide this metric by using the reflection from the ground and the Doppler shift of the signal. If the ends of a vertical waveguide are open, then the signal may be emitted out the bottom. The signal may then reflect off the ground and be received by the receiver. This ground reflection is discriminated from the paddle reflections as the round-trip distance is much larger, moving the demodulated frequency higher. One advantage of using this method over a GPS speed measurement is that the update rate of the FMCW radar may be set much higher. However, both the GPS speed measurement and the FMCW radar may be used together for calibration purposes or for redundancy/over-determination of the speed.

The FMCW radar system may also be used to measure the moisture content of grain. Because water molecules polarize and align in the presence of an electric field, it has a very high relative permittivity. This effect may be used to measure the moisture content of grain using a capacitive sensor, where the grain functions as a dielectric between the capacitor plates. The effect is temperature-dependent, so the capacitance measurements must be temperature corrected. Further, because increasing the density of grain packing increases the amount of water present in the grain for a given volume, the capacitance increases with increased density. Therefore, the density must be either measured or controlled. For a static (stationary) grain sample, the temperature and density may be measured and accounted for reliably. Many bench-top testers measure the temperature of the grain sample and either weigh the grain or accept a standard weight of grain for a test sample, and require the grain be freely poured into a fixed volume container for consistent packing. Though measuring the temperature of flowing grain is feasible as the grain temperature changes relatively slowly, measuring and/or controlling the density of flowing grain is much more challenging.

As well as the capacitance of the grain changing with moisture content, RF signal attenuation also changes. This is because an oscillating electric field causes the water molecules to vibrate, and the damping of this vibration dissipates heat; this is the principle behind a microwave oven. The measurement of this loss/attenuation is another way to measure the moisture content of grain and is also dependent on temperature and density. Therefore, capacitance and attenuation are both independent functions of moisture, temperature, and density. Previous techniques have used the transmission of a microwave signal through a controlled thickness of grain and measured the phase shift and attenuation caused by the grain, where the phase shift is related to the capacitance, with the ratio of the phase shift to the attenuation serving as a measurement of moisture content independent of density, provided the temperature is known. In one embodiment, a modification of this technique is implemented to instead reflect this signal off a sample of grain rather than transmit through the grain, simplifying the measurement apparatus by avoiding the need for a chamber to contain the measured grain. From the measured attenuation and phase shift of the reflected signal, the moisture and density may be determined. When an FMCW signal reflects off a dielectric interface, the demodulated reflection properties (frequency, phase, and/or amplitude) are functions of the distance to the dielectric interface and the complex impedance of the two materials constituting the interface. By knowing the incident material impedance and reflection coefficient, the impedance of the material after the dielectric interface boundary may be determined.

Reflections of electromagnetic waves occur from an impedance mismatch between transmission mediums. For a change in impedance from Z₁ to Z₂, the reflection coefficient (Γ) and transmission coefficient (T) are given by:

$$Γ = \frac{{Z}_{2} - {Z}_{1}}{{Z}_{2} + {Z}_{1}}$$

$$T = \frac{2 {Z}_{2}}{{Z}_{2} + {Z}_{1}}$$

Using this relationship, it is possible to determine the impedance of a material using the measured reflection coefficient (Γ) resulting from the mismatch between the known impedance (Z₁) and the unknown impedance (Z₂) of the adjacent material. For an electromagnetic wave traveling through a medium, the impedance may be represented as:

$$Z = \sqrt{\frac{μ}{ε}}$$

where ε and μ are the permittivity and permeability of the medium, respectively.

Dielectric materials, such as water (and therefore grain) are non-ferromagnetic, so their permeability is equal to the permeability of free space, and the complex permittivity is related to the capacitance (real) and dielectric losses (imaginary). Therefore, once the impedance of the dielectric material is known, the capacitance and losses may be determined.

The reflection coefficient may be determined by measuring the change in amplitude and phase introduced by the dielectric interface as seen at the receiver, which requires knowing the amplitude and phase of the incident signal. An embodiment utilizes a reference reflector (sampling reflector) with known properties at a given distance from the receiver that reflects (samples) a small portion of the incident signal. Using the reference reflector, the receiver may determine the amplitude of the incident signal at the sampling reflector (based on waveguide 130 and reflector geometries), which would be constant over the length of the waveguide 130 up to and including the dielectric interface assuming the portion reflected to be small and using a lossless medium. However, to compare the phases of the reflections from the dielectric interface and sampling reflector, the signals must have traveled the same distance. As the reflector may be located separately from the interface, the phase of the reflection from the sampling reflector may be translated to make it appear to be co-located with the dielectric interface. The translation may be achieved by offseting the phase by twice the difference in the distances between each reflector and the receiver.

By comparing the reflected and inferred incident signals from the dielectric interface, the reflection coefficient may be determined as the ratio of the complex phasors:

$$Γ = \frac{{A}_{Reflected} {e}^{j {∅}_{Reflected}}}{{A}_{Incident} {e}^{j {∅}_{Incident}}}$$

If the dielectric interface is between two non-ferromagnetic magnetic materials, the relationship between reflection coefficient and impedance may rewritten solely as a function of permittivity:

$$Γ = \frac{\sqrt{{ε}_{1}} - \sqrt{{ε}_{2}}}{\sqrt{{ε}_{1}} + \sqrt{{ε}_{2}}}$$

If the first dielectric is air or a vacuum and the waveguide 130 cross-sectional area is sufficiently large relative to the signal's frequency, the relative permittivity is close to 1 and this may be simplified to:

$$Γ = \frac{1 - \sqrt{{ε}_{2}}}{1 + \sqrt{{ε}_{2}}}$$

The permittivity of the material may then be determined as follows:

$$ε = {( \frac{Γ - 1}{Γ + 1} )}^{2}$$

As discussed, the capacitive and loss components may be represented as a complex permittivity, where the real component represents the dielectric constant, and the imaginary represents the dielectric loss factor as follows:

$$ε = {ε}_{real} - j {ε}_{imag}$$

Because the grain's capacitance is determined by the real component and the loss by the imaginary component, each of these components is a function of moisture, temperature, and density. If the temperature is measured directly, the measurement of the capacitance and loss allows both the moisture and the density to be determined.

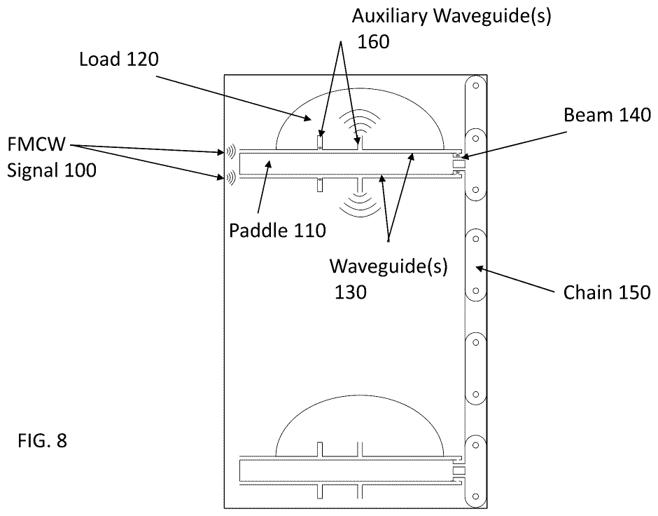

In an embodiment, the permittivity of the grain sample may be determined by inserting an aperture in the grain yield monitor's paddle-based waveguide 130 located such that it is covered by the grain pile, and another aperture with a reflective end for use as a reference reflector. This introduces a dielectric interface due to the change from the waveguide's nominal impedance, which when measured may be used to determine the permittivity and ultimately the moisture content of the grain sample. Alternatively, the same aperture used to measure the grain moisture may also be used as the reference, by utilizing a second radar to measure the same aperture while the paddle 110 travels down the elevator 300, as the aperture is not covered by grain during this phase of the elevator cycle. The change in measured dielectric properties between empty and loaded phases may then be used to determine the dielectric properties of the grain. In addition to grain elevators 300 this method may be applied to screw conveyor type mechanisms or any system where grain is flowing past an aperture and the moisture and/or density sensing may be applied in any suitable location of the conveyance such that grain comes into direct contact with the FMCW signals. FIG. 8 depicts embodiments for determining the moisture content and bulk density as well as volume and grain pile shape as described in the sections that follow.

One embodiment determines the temperature of the grain by measuring the amount of thermal expansion or contraction of a known length of waveguide 130 by using sampling reflectors that are located a known nominal distance from each other (larger distances increases accuracy). As the propagation velocity is unchanged over temperature, the measured phase difference between reflectors indicates the geometry (scale) of the apparatus, which is subject to thermal effects. In FIG. 8, this may be the distance between the reference reflector and the aperture used to measure the grain moisture/density, but in the auxiliary waveguide 160 pointing downward so that the temperature measurement is not affected by the dielectric properties of the grain. To accurately monitor the grain temperature, an auxiliary waveguide 160 may extend upwards from the paddle 110 such that it contacts the grain sample and acclimates to its temperature. Calibration of this system may be performed when the clean grain elevator 300 is empty for a period sufficient to reach ambient temperature. Because the paddle 110 carries grain approximately 50% of the time when harvesting, the paddle 110 attains a steady-state temperature of roughly the average of the grain pile and the ambient temperature. The time required to reach this steady state is determined by the specific heat of the various components and starting temperature difference between the grain and ambient temperature. An alternate embodiment locates the temperature sensing system at the bottom of the clean grain elevator 300 so that the sensor may remain in continuous contact with the grain, avoiding the toggling between loaded and empty paddles.

In embodiments, the volume of the grain piled on a yield monitor paddle 110 may be estimated by directing an FMCW signal 100 downward from the preceding paddle 110 to determine the distance to the pile of interest. This may be achieved by inserting an aperture in the second waveguide 130 (otherwise used for measuring the deflection of the lower face of the bending beam 140) facing downward. The location of the aperture along the waveguide 130 may be optimized to sense the peak of the grain pile. The pile height may be determined using the measured distance to the pile, knowing the unladen distance and the displacement of each paddle due to weight. The unladen distances may be characterized by measurements taken when the clean grain elevator 300 is empty, measuring the speed of the chain 150 and the knowing the number of paddles 110 on the chain. The displacement of each paddle 110 may be determined from the measured deflection of the bending beam 140, the location of the measurement along the beam 140, and knowledge of the beam's geometry. Once the pile height is known, a volume may be estimated using the angle of repose for a given crop type assuming a shape profile (cone, truncated cone, pyramid, etc.). Using the estimated volume of the pile and its respective weight measurement, a secondary bulk density metric may be generated in addition to one determined using permittivity for improved accuracy.

An embodiment may optimize the frequency with which the unladen paddle distances are measured by duplicating measurements on the empty side of the clean grain elevator 300. This may be accomplished by duplicating the FMCW equipment or using waveguides 130 with multiple apertures to make measurement at multiple locations.

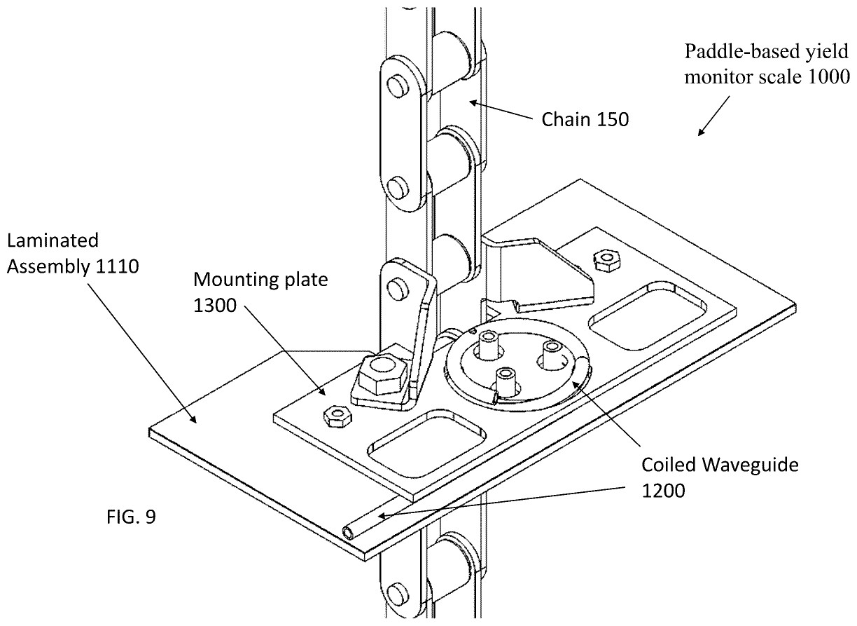

FIG. 9 depicts an example of a paddle-based yield monitor scale 1000 (viewed from the underside) which may be implemented in a paddle, such as the paddle 110 of a clean grain elevator. The paddle-based yield monitor scale 1000 may be implemented in the systems described herein in order to measure a load on a paddle 110. The paddle-based yield monitor scale 1000 may be embedded in, included with, or is the paddle 110 for a clean elevator system 300. The paddle-based yield monitor scale 1000 includes a laminated assembly 1110, a mounting plate 1300, and a coiled waveguide 1200. The paddle-based yield monitor scale 1000 is connected to the paddle chain 150. The coil waveguide is configured to direct a signal from a FMCW radar unit (not shown) to the plate surface of the laminated assembly 1110 which is attached to the mounting plate 1300 at a plurality of points on the laminated assembly that each deflect elastically under load. The paddle-based yield monitor scale 1000 may be incorporated into a paddle of a clean grain elevator, such as by enclosing, or otherwise providing a grain supporting surface coupled on top of, the paddle-based yield monitor scale 1000.

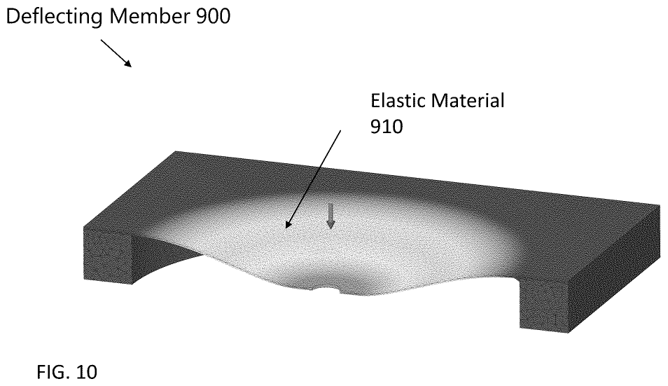

FIG. 10 depicts an example of the deflecting mechanism used in a low-profile non-instrumented deflecting member 900. One or more such deflecting members 900 may be used to measure the yield data when attached or incorporated into, for example, a paddle 110 as described in FIG. 9 above, e.g., the paddle surface, which conveys a grain pile, acts as the scale platform that deflects downward (slightly) with load such that the FMCW can sense the deflection and infer the force based on the sensitivity (how much deflection per load force). Incorporation of the deflecting member 900 in a paddle-based yield monitor scale 1000 design is described in FIGS. 9 and 11-21. The deflecting member 900 is configured with a thin layer of elastic material 910 (for example spring steel) that is laminated to a rigid fixed layer with circular cut-outs or reliefs allowing the elastic material to deflect linearly when a load (for example, the paddle 110 or load 120) is applied at the circle's centre. The elastic material 910 deflects in a manner akin to a circular trampoline loaded at its centre where deflection is concentrated and linear with applied force. FIG. 10 illustrates the geometry and relationship between stress and strain when the elastic material 910 deforms.

These type of low-profile non-instrumented deflecting members 900 may be arranged to each support one of a plurality of legs of a rigid platform to create a low-profile force sensitive platform that deflects under load with respect to a fixed layer. The force sensitive platform may be used in a paddle-based yield monitor scale design 1000 to provide yield data by measuring the force/weight that is placed on or applied to the platform, for example by a load placed on a paddle 110. The system may be inverted such that the legged platform is fixed while a rigid layer with circular cut-outs laminated to the elastic layer deflects. By arranging the collection of identical non-instrumented deflecting members 900 in a geometrically symmetric pattern such as the vertices of a triangle, square, or pentagon (etc.), the geometric centre of the pattern deflects linearly with load regardless of where the load is applied to the surface of the platform. This property allows the superposition of any number of forces or a distributed load (pile of material) to be accurately measured using a FMCW signal 100 from the FMCW system (not shown) monitoring deflection at this location, thus instrumenting the low-profile force sensitive plate that comprises (in part) the collection of the deflecting members 900. The platform may tilt with respect to the fixed layer if the load's centroid is not located at the geometric centre of the deflecting member 900 arrangement. This tilt has minimal effect on measurement accuracy as the deflection sensed by the FMCW system approximates the average deflection across the viewing area, which with proper aiming represents the deflection at the intended central location.

Increasing the number of non-instrumented deflecting members 900 employed in the platform design improves platform stability at increased manufacturing cost (machining and materials). The range of useful geometric patterns may be extended to include a line segment (just two deflecting members 900) though this arrangement lacks off-axis stability leading to increased off-axis tilt. Conversely and taken to the extreme, the geometric pattern could have infinite vertices (a circle) so that the corresponding deflecting members 900 intersect and overlap to become a ring of elastic material supported by the rigid fixed layer both inside and outside the ring, and whose width is the diameter of individual circular cut-outs. The mid-radius of the ring supports the platform whose footprint becomes a solid ring of narrow width as each of the infinite number of vertices has a corresponding leg that intersects and overlaps its neighbor to form the ring.

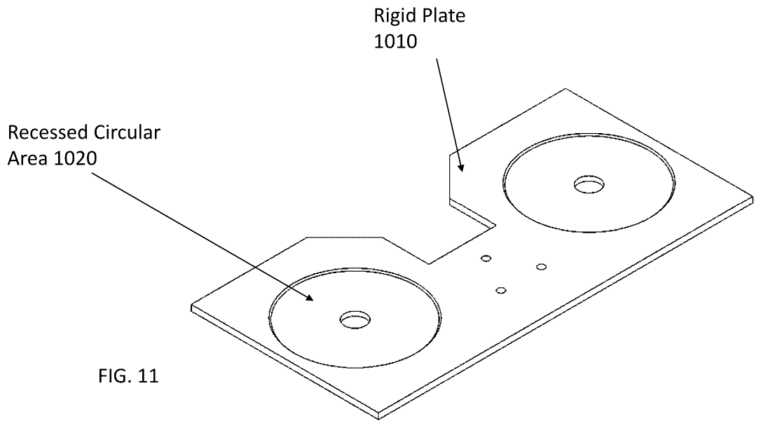

There are many useful applications for such a low-profile force sensitive plate including a paddle-based yield monitor scale design 1000 in a clean grain elevator 300 as it benefits from the properties of this approach, which include a low-profile form-factor, single point of measurement, insensitivity to load location, and linear sensing. FIGS. 9 and 11-21 depict various components and connections of the paddle-based yield monitor scale design 1000 that uses a low-profile force sensitive plate based on the low-profile non-instrumented deflecting member 900 of FIG. 10. The paddle-based yield monitor scale design 1000 may be implemented in the clean grain elevator system 300, the yield measuring systems of FIGS. 1 and 2, or any other system described herein that uses the FMCW for yield measurement. In the paddle-based yield monitor scale design 1000, a rigid plate 1010 provides recessed circular areas 1020 into which an elastic layer 1100 made of elastic material 910 that is laminated to the rigid plate 1010 may deflect under load. FIG. 11 depicts a rigid plate 1010 of the paddle-based yield monitor scale design 1000. The rigid plate 1010 includes an outline configured to avoid the paddle-chain 150; the holes at the centre of each recess are included for practical access to mounting and assembly hardware such as nuts and bolts.

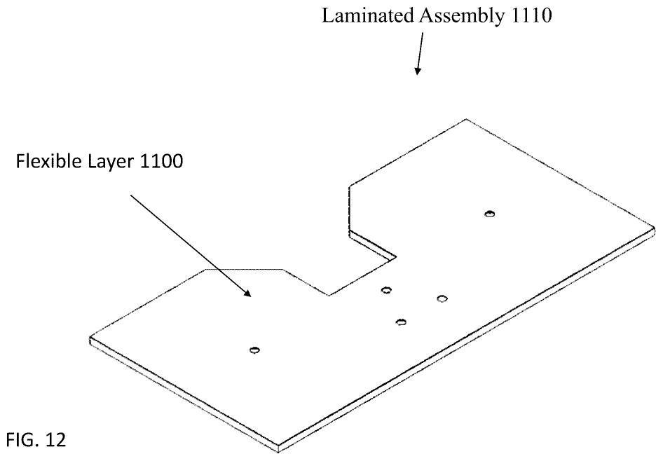

FIG. 12 depicts a thin flexible layer 1100 laminated to the rigid plate 1010 (not shown but located underneath the laminated assembly 1110). The resulting laminated assembly 1110 may be used in the paddle-based yield monitor scale design 1000.

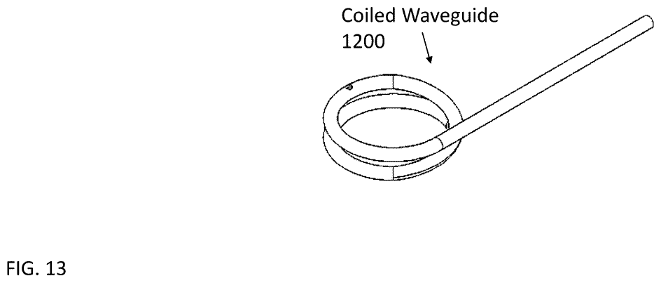

FIG. 13 depicts a coiled waveguide 1200 that directs the signal from an FMCW radar device (not shown but located, for example at the right-hand side) upward through the top port on the side of the waveguide 1200. The coiled waveguide 1200 may be connected to or embedded in a paddle 110, such as the paddle 110 of FIG. 1 or used in the paddle-based yield monitor scale design 1000. The coiled waveguide 1200 carries a FMCW signal 100 from the FMCW radar unit (not shown) to the geometric centre of the dual deflecting member 900 line-segment geometric arrangement where the upward-facing side-port is located, avoiding practical obstacles such as mounting and assembly hardware. An optional second loop may be provided so that a downward-facing side-port aligned with the first port but facing in opposing direction may be located farther along the waveguide's length to allow differential operation with a single FMCW measurement. For this, an additional reflector that is offset from but rigidly attached to the moving assembly may be used in the path of the downward port so that the distances measured by upward and downward facing ports act as components of a differential signal. The additional length of the coiled waveguide 1200 between the two ports allows a FMCW system to resolve the individual deflection components, which are then combined for a differential result. Differential operation is useful in removing effects of variable common-mode delays introduced by electrical, thermal, and mechanical apparatus and phenomena.

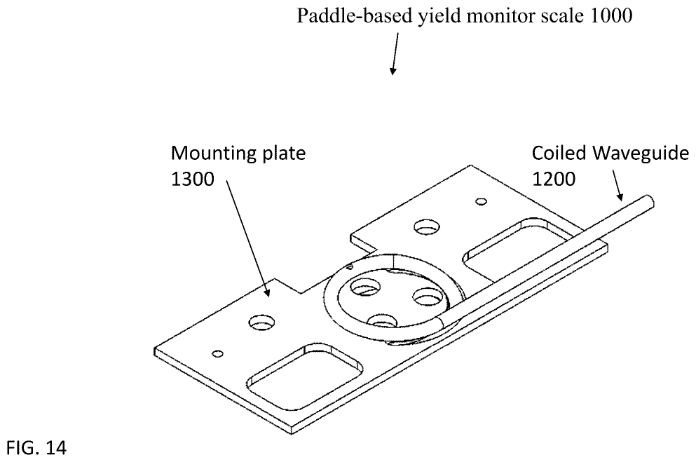

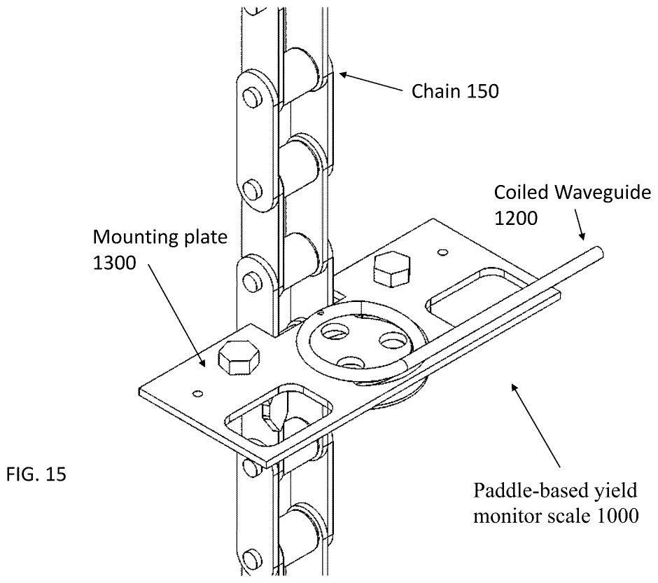

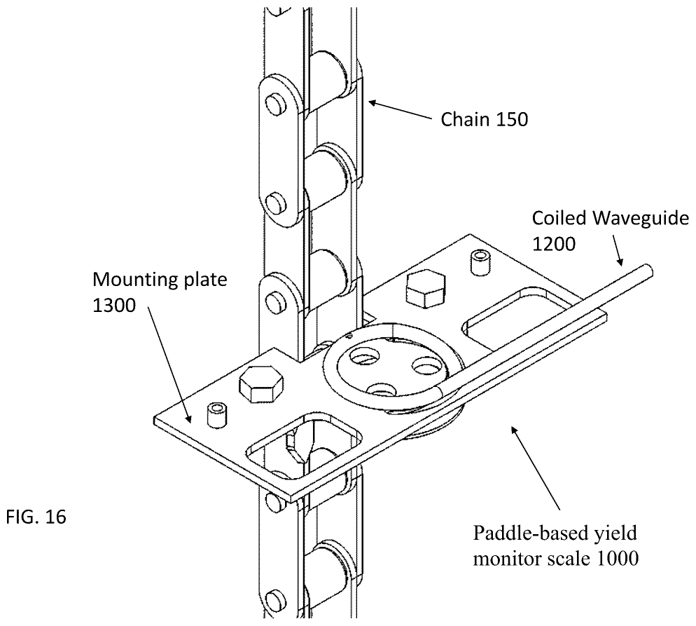

FIG. 14 depicts where the waveguide 1200 is assembled to a mounting plate 1300 of the paddle-based yield monitor scale design 1000. The mounting plate 1300 is attached to a paddle chain 150 using standard chain attachment links and fasteners, as shown in FIGS. 15 and 16. The mounting plate 1300 is shown with several optional cut-outs for practical mounting purposes or to reduce material usage and weight.

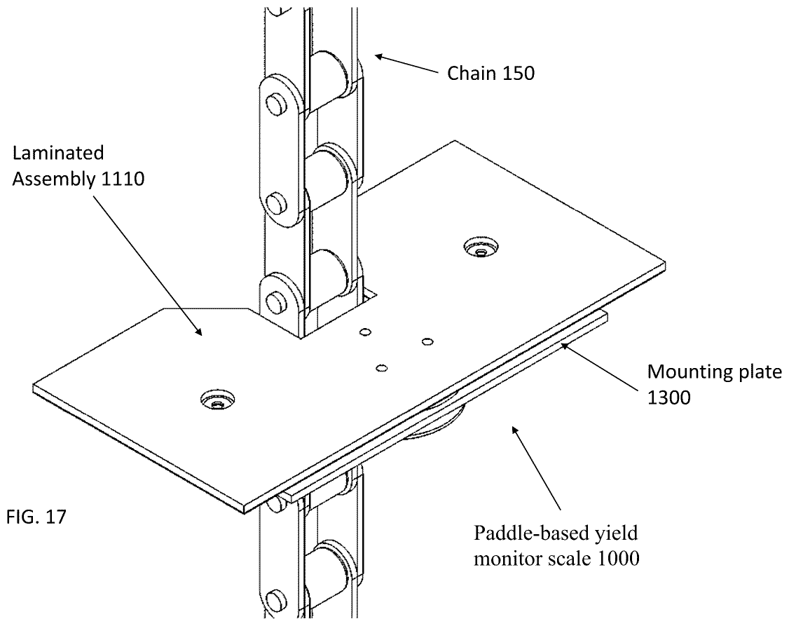

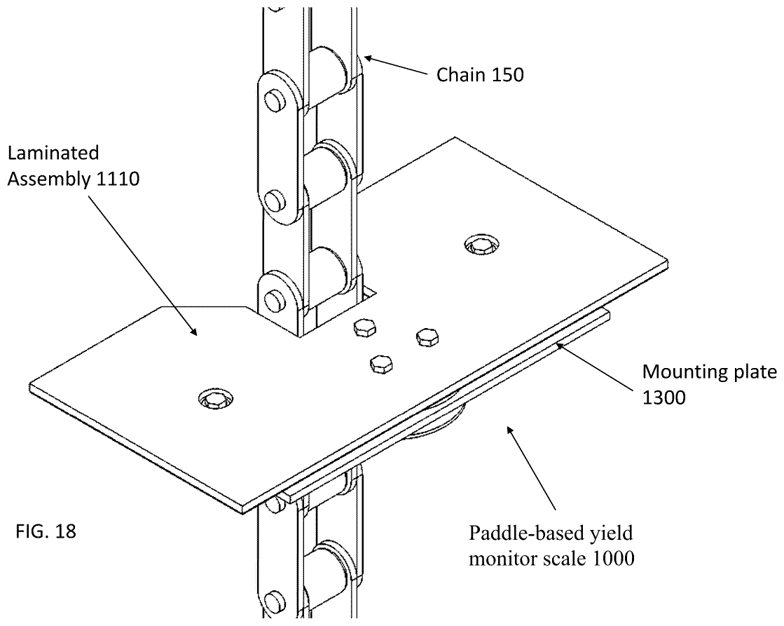

The laminated assembly 1110 may be attached to but stood off from the mounting plate 1300 using appropriate connections as depicted in FIGS. 17 and 18, which may include nuts, bolts, standoffs, or other fasteners for example. The mounting plate 1300 (located underneath the laminated assembly 1110) with assembly hardware acts as the legged platform in the inverted scenario described previously such that the laminated assembly 1110 deflects downward with load 120 causing the elastic layer 1100 on the underside of the laminated assembly 1110 to deflect upward into the recesses. The distance from the laminated assembly 1110 to the waveguide's viewing port, and thus to the FMCW radar, decreases with increased load allowing the FMCW radar to directly measure deflection. Force may be determined through a calibration process relating a given deflection and known force or may be modeled based on material properties and geometry. Care should be taken to ensure no practical restrictions impede reasonable deflections, and optionally, may be added to prevent excessive and unintended strain or bending.

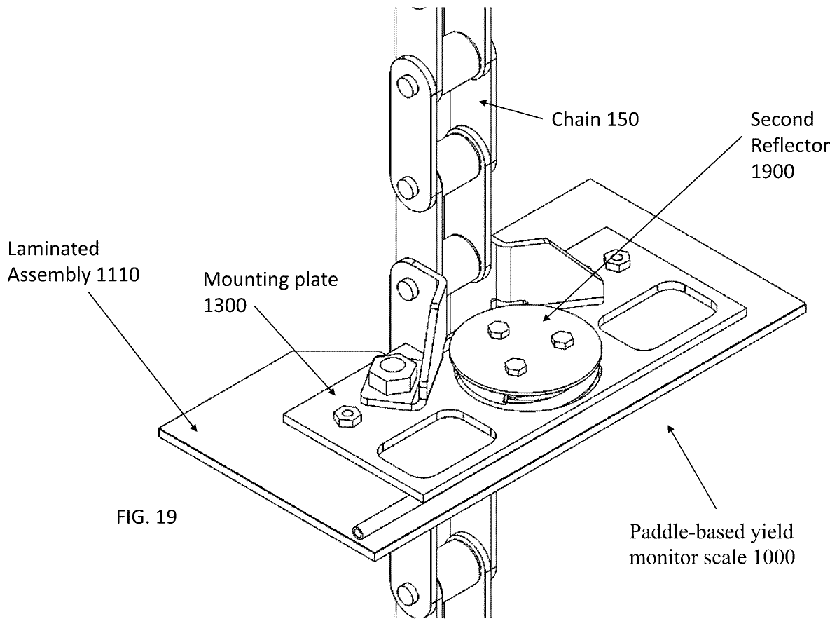

As viewed from beneath (as depicted in FIG. 19), the paddle-based yield monitor scale design 1000 provides a mechanism for mounting (stand-offs) a second reflector 1900 for differential operation to the laminated assembly.

The second reflector 1900 is depicted as round though any practical shape or mounting mechanism may be employed.

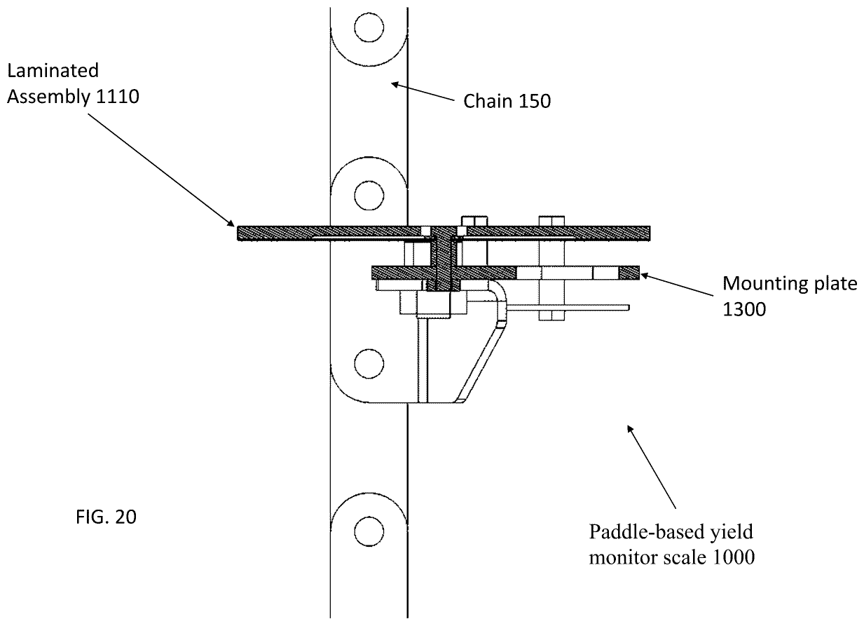

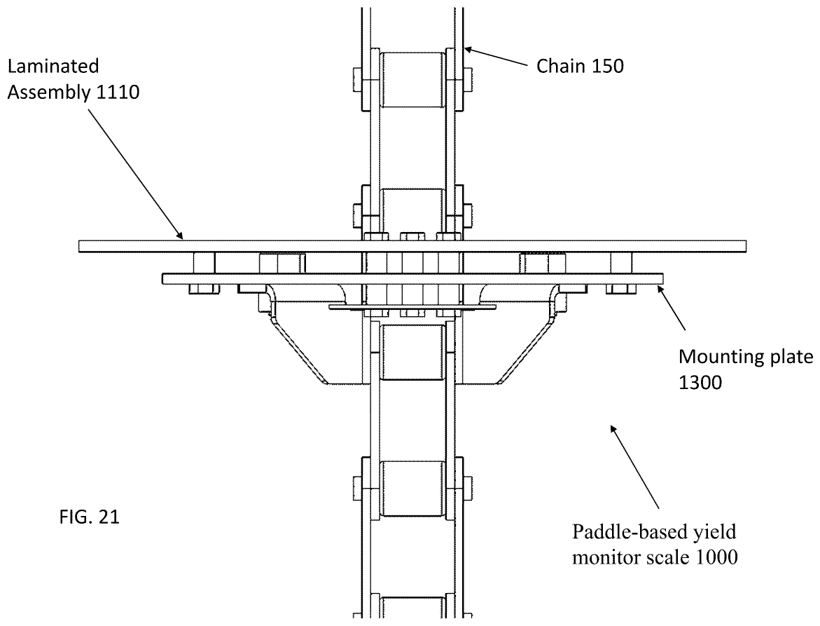

FIGS. 20 and 21 depict cross-sectional views of the paddle-based yield monitor scale design 1000. The access holes in the top plate at the centre of each recess must be covered and bridged so that all load materials contribute to the deflection, and none can plug the mechanism.

Other embodiments may rely on the volume generated from the weight and bulk density measurements, along with the angle of repose, the footprint of the paddle of the clean grain elevator, such as paddle 110 and grain pile height measurement to provide an improved estimate of grain pile shape due to the increased number of constraints.

Each paddle of the clean grain elevator, such as paddle 110 may be interchangeable to ease parts inventory requirements and installation/replacement effort. However, a paddle of the clean grain elevator, such as paddle 110, may require individualized calibration to compensate for its specific sensitivities for weight, moisture, bulk density, and/or volume, etc. To provide the correct calibration applied to a paddle 110 the system must correctly identify that paddle 110. As paddles 110, may not contain active electronics, signaling their identity may present challenges. A simplified method to uniquely identify each paddle 110 involves identifying a reference point along the chain 150 through use of a reflector with a unique reflection signature (distance to the radar or duration of reflection etc.), and tracking each paddle 110 that follows, in sequence. To do this, the system may need knowledge of the total number of paddles 110 present in the entire chain 150.

The temperature, moisture content, and/or density of grain may be measured in a distributed fashion throughout a storage tank or bin. This may allow grain farming operations to monitor for spoilage, which may be indicated by a localized temperature increase. As the spoilage may be isolated to a small section of grain, it may be necessary to distribute many temperature sensors throughout the volume of grain.

In an embodiment, a waveguide system is provided that includes a single main waveguide tube 130 with an arbitrary number of auxiliary waveguide tap points 160 that measure temperature of the apparatus (a proxy for the surrounding grain sample), as well as the complex permittivity of the grain sample allowing determination of moisture content and density.

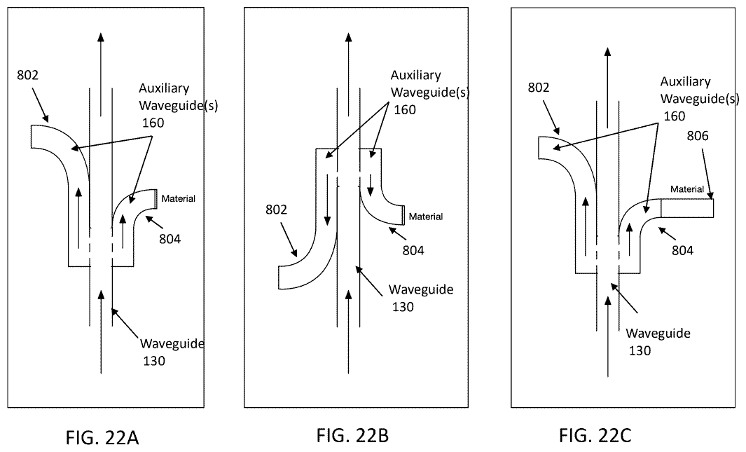

FIGS. 22A and 22B depict an example sensor. FIGS. 22A and 22B employ forward and reverse (Bethe) directional couplers respectively (not shown). A directional coupler is a waveguide aperture arrangement employing constructive and deconstructive wave interference to control the directionality of the signal passed through the coupler. The two configurations illustrated above use a multi-hole and Bethe-hole coupler on the left and right embodiment respectively. A multi-hole coupler employs coupling holes that are spaced a specific distance apart based on the wavelength of interest. The resultant coupled signal is directed in a forward direction with respect to the incident signal. A Bethe coupler uses a single narrow-width hole and causes the resultant coupled signal to propagate in the opposite direction to that of the incident signal. The coupling factor is correlated to the size of the holes used, and the bandwidth and shape of the frequency response is affected by the hole shape. The use of directional couplers minimizes multiple reflections along the waveguide, improving the system's performance. The operation will be described for the left configuration, but it is understood that it applies equally to either variant. The coupler diverts a (for example, small) portion of the incident signal along an auxiliary waveguide 160 for localized FMCW radar-based measurements while the balance continues along the main waveguide for subsequent down-stream measurements. These embodiments direct portions of the incident signal to the left and right arms such that the signal is split with some portion traveling along each arm waveguide and the remainder continuing down the main waveguide where more measurement apparatus may be cascaded.

In FIGS. 22A and 22B, the left arm 802 of each sensor is used to measure the temperature, while the right 804 is used to measure complex permittivity for determination of moisture content and density. Given the coefficient of thermal expansion of the waveguide material, the left arm 802 may be used to determine temperature by measuring changes in phase shift between the directional coupler and the capped end of the waveguide with respect to a baseline measurement taken at a known (calibrated) temperature. The left and right arms 802 804 may be configured to be different lengths (as shown) to ease isolating the respective reflections through spatial separation. The end of the right arm 804 may be immersed in the grain sample providing a reflection based on the impedance mismatch at the dielectric interface between the sample and the dielectric of the waveguide, typically 1 for air or a vacuum. If the amplitude and phase of the incident signal are known, the amplitude and phase of the reflection from the dielectric interface may then be used to determine the reflection coefficient and in turn the complex permittivity of the grain, from which the moisture and density may be determined using the measured temperature. The phase and amplitude of the signal that is incident at the dielectric interface may be estimated by measuring the phase shift between the directional coupler and the capped end of the left waveguide 160 and adjusting the phase based on the ratio of the lengths for the two arms 802 804. Both left and right auxiliary waveguides 160 are shown with identical curves to minimize differences in waveguide performance.

Another embodiment employs a hollow chamber 806 closed on one end, constructed of a material that is approximately transparent to the FMCW signal, and attached to the end of a waveguide to form a dielectric interface. The chamber 806 geometry increases the surface area of the dielectric interface formed between the waveguide and grain sample beyond that of the waveguide's cross-section for a more representative (averaged) measurement of impedance and ultimately moisture and density. An embodiment employs a tubular chamber 806 of cylindrical, rectangular, or other cross-section to provide reflections from the grain surrounding the surface of the chamber down its length, spreading the reflections in time and demodulated intermediate frequencies (IF). Such a chamber may be implemented with one or more transparent sides, where the remaining sides are metallic to reflect and guide the incident signals. The spread of IF frequencies may provide for additional analytical methods as well as redundancy/noise immunity. An example of this type of sensor is depicted in FIG. 22C.

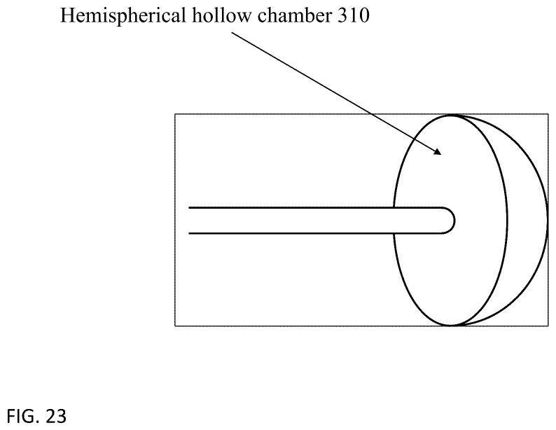

Another embodiment employs a hemispherical hollow chamber 310 such that the grain being sampled is equidistant from the waveguide opening. This allows for the samples to demodulate to a single IF frequency instead of the range of frequencies associated with the embodiment above. An example of this embodiment is depicted in FIG. 23.

A cascaded sensor system may be employed vertically (in the case of a grain bin), horizontally (in the case of a grain cart storage hopper), or a combination of both to allow for both vertical and horizontal spatial measurements in a grain storage system.

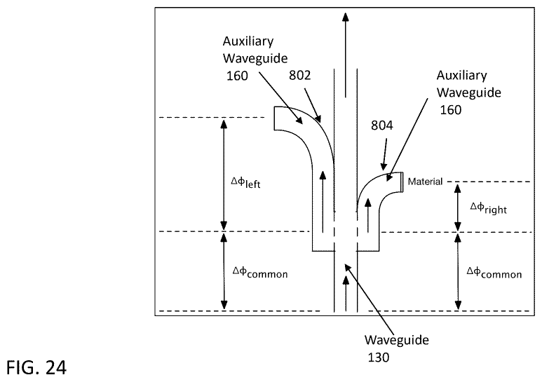

FIG. 24 depicts a sensor with three phase shifts defined. The phase shift Δφ_{common} is defined as the signal's phase shift from the entrance of the sensor to the co-located directional couplers. The phase shifts from the coupler to the ends of the left and right arm 802 804 are denoted by Δφ_{left} and Δφ_{right}, respectively. These are measured along the curve of the left and right portion on the sensor. Due to the lossless nature of waveguides 130, the signal amplitude is not significantly attenuated as the signal travels along the waveguide. Only where the signal reaches an impedance mismatch is its amplitude affected.

The phase shift through the transmit signal chain and antenna is Δφₜₓ. Similarly, the phase shift through the receive antenna and the receive signal chain is Δφᵣₓ.

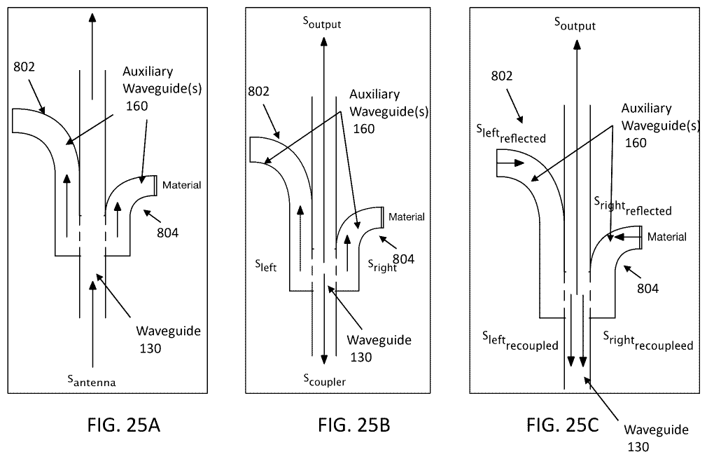

An FMCW chirp signal as depicted in FIG. 25A is emitted from the transmit antenna and propagates along the waveguide 130 and may be represented by:

$${S}_{antenna} ( t ) = A {e}^{j ω t} {e}^{- j Δ {ϕ}_{t x}}$$

As the signal propagates from the antenna along the waveguide 130, the signal reaches an impedance mismatch at the each of the co-located left and right directional couplers. FIG. 25B depicts the source locations and propagation directions of four signals that result from this occurrence: a reflection from the co-located directional couplers back towards the radar (S_{coupler}), a signal coupled into the right arm 804 (S_{right}), a signal coupled into the left arm 802 (S_{left}), and a signal that carries on along the waveguide (Sₒᵤₜₚᵤₜ).

If Γ_{coupler} is the complex reflection coefficient of the two co-located couplers, the reflected signal from the coupler may be represented by:

$${S}_{c o u p l e r} ( t ) = A {Γ}_{c o u p l e r} {e}^{j ω t} {e}^{- j Δ {ϕ}_{t x}} {e}^{- j Δ {ϕ}_{c o m m o n}}$$

If C_{right} is the complex coupling factor of the directional coupler coupled to the right arm 804, defined as the ratio of the signal coupled into the right arm 804 to that of the incident signal, the signal coupled into the right arm may be represented by:

$${S}_{right} ( t ) = A {C}_{right} {e}^{j ω t} {e}^{- j Δ {ϕ}_{t x}} {e}^{- j Δ {ϕ}_{c o m m o n}}$$

Similarly, if C_{left} is the complex coupling factor of the directional coupler coupled to the left arm, defined as the ratio of the signal coupled into the left arm to that of the incident signal, the signal coupled into the left arm may be represented by:

$${S}_{left} ( t ) = A {C}_{left} {e}^{j ω t} {e}^{- j Δ {ϕ}_{t x}} {e}^{- j Δ {ϕ}_{c o m m o n}}$$

If C_{coupler} is the complex coupling factor through the directional coupler, the signal propagating from the coupler toward the end of the main waveguide 130 may be represented by:

$${S}_{output} ( t ) = A {C}_{c o u p l e r} {e}^{j ω t} {e}^{- j Δ {ϕ}_{t x}} {e}^{- j Δ {ϕ}_{c o m m o n}}$$

FIG. 25C depicts the source locations and propagation directions of the reflected and recoupled return signals, that are described in the following sections:

The signal coupled to the right arm 804 auxiliary waveguide 160 will propagate along its length and be phase shifted by Δφ_{right} before it reaches the grain. If Γ_{grain} is the complex reflection coefficient of the dielectric interface between the grain sample and the waveguide 130, the impedance mismatch introduced by the grain sample causes a reflection that may be represented by:

$${S}_{{right}_{reflected}} ( t ) = A {C}_{right} {Γ}_{g r a i n} {e}^{j ω t} {e}^{- j Δ {ϕ}_{tx}} {e}^{- j Δ {ϕ}_{c o m m o n}} {e}^{- j Δ {ϕ}_{right}}$$

Similarly, the signal coupled to the left arm 802 auxiliary waveguide 160 will propagate along its length and reach the capped end of the waveguide at a phase distance of Δφ_{left}. If Γ_{cap} is the complex reflection coefficient of the interface between the (reflective) cap and the left portion of the auxiliary waveguide, the signal reflected off the end cap may be represented by:

$${S}_{{left}_{reflected}} ( t ) = A {C}_{left} {Γ}_{c a p} {e}^{j ω t} {e}^{- j Δ {ϕ}_{t x}} {e}^{- j Δ {ϕ}_{c o m m o n}} {e}^{- j Δ {ϕ}_{left}}$$

The signal reflected from the grain sample propagates back along the right arm 804 auxiliary waveguide 160 and re-enter the directional coupler in the reverse direction, shifting the phase by Δφ_{right} a second time. This signal then recouples back into the main waveguide 130 and propagates back towards the radar receiver. The coupling factor, C_{right}, is applied both times the coupling occurs so the signal may be represented by:

$${S}_{{right}_{r e c o u p l e d}} ( t ) = {S}_{{right}_{reflected}} {C}_{right} {e}^{- j Δ {ϕ}_{right}} = A {C}_{right}^{2} {Γ}_{g r a i n} {e}^{j ω t} {e}^{- j Δ {ϕ}_{tx}} {e}^{- j Δ {ϕ}_{c o m m o n}} {e}^{- j 2 {Δϕ}_{right}}$$

Similarly, the signal reflected from the cap at the end of the left arm 802 propagates back along the left arm 802 auxiliary waveguide 160 and re-enter the directional coupler in the reverse direction, shifting the phase by φ_{left} a second time. This signal then recouples back into the main waveguide 130 and propagates back towards the radar receiver. The coupling factor, C_{left}, is applied both times the coupling occurs so the signal may be represented by:

$${S}_{{left}_{r e c o u p l e d}} ( t ) = {S}_{{left}_{reflected}} {C}_{left} {e}^{- j Δ {ϕ}_{left}} = A {C}_{left}^{2} {Γ}_{cap} {e}^{j ω t} {e}^{- j Δ {ϕ}_{tx}} {e}^{- j Δ {ϕ}_{c o m m o n}} {e}^{- j 2 {Δϕ}_{left}}$$

The portion of the signal that is not recoupled into the main waveguide 130 reflects and travel back towards the opposite end of the specific arm. This signal continues to propagate back and forth within the arm with each successive reflection/recouple cycle reducing the amplitude. The relative lengths of the apparatus may be configured such that the additional signals do not coincide with path lengths equivalent to other signals of interest (causing the demodulated IF frequencies to overlap). The coupling factor may be asymmetric such that it differs depending on the direction of signal propagation. In this case, instead of a single coupling factor such as C_{right}, there are exist two separate values, such as C_{right}_{ᵢₙ} and C_{right}_{ₒᵤₜ}, with a similar set of factors for the left arm.

The signal received at the radar corresponding to reflection from the coupler may be represented by:

$$R {x}_{c o u p l e r} = {S}_{c o u p l e r} ( t ) {e}^{- j Δ {ϕ}_{c o m m o n}} {e}^{- j Δ {ϕ}_{r x}} = A {Γ}_{c o u p l e r} {e}^{j ω t} {e}^{- j Δ {ϕ}_{t x}} {e}^{- j 2 Δ {ϕ}_{c o m m o n}} {e}^{- j Δ {ϕ}_{r x}}$$

The measured received signal at the radar Rx_{coupler} may also be represented in terms of measured amplitude and phase by:

$$R {x}_{c o u p l e r} = {A}_{c o u p l e r} {e}^{j ω t} {e}^{- j {ϕ}_{coupler}}$$

The signal received at the radar corresponding to the reflection from the grain sample may be represented by:

$$R {x}_{right} = {S}_{{right}_{r e c o u p l e d}} {e}^{- j Δ {ϕ}_{c o m m o n}} {e}^{- j Δ {ϕ}_{r x}} = A {C}_{right}^{2} {Γ}_{g r a i n} {e}^{j ω t} {e}^{- j Δ {ϕ}_{t x}} {e}^{- j 2 {Δϕ}_{c ommon}} {e}^{- j 2 Δ {ϕ}_{right}} {e}^{- j Δ {ϕ}_{r x}}$$

The measured received signal at the radar Rx_{right} may also be represented in terms of measured amplitude and phase by:

$$R {x}_{right} = {A}_{right} {e}^{j ω t} {e}^{- j {ϕ}_{right}}$$

Similarly, the signal received at the radar corresponding to the reflection from the capped end of the left arm auxiliary waveguide may be represented by:

$$R {x}_{left} = {S}_{{left}_{r e c o u p l e d}} {e}^{- j Δ {ϕ}_{c o m m o n}} {e}^{- j Δ {ϕ}_{r x}} = A {C}_{left}^{2} {Γ}_{cap} {e}^{j ω t} {e}^{- j Δ {ϕ}_{t x}} {e}^{- j 2 {Δϕ}_{c ommon}} {e}^{- j 2 Δ {ϕ}_{left}} {e}^{- j Δ {ϕ}_{r x}}$$

The measured received signal at the radar Rx_{left} may also be represented in terms of measured amplitude and phase by:

$$R {x}_{left} = {A}_{left} {e}^{j ω t} {e}^{- j {ϕ}_{left}}$$

As the apparatus may expand and contract with temperature, the waveguide lengths may be configured and fabricated ratiometrically with respect to a reference. In the case of this sensor, the left arm 802 auxiliary waveguide 160 may act as the reference, and this length may also be used to measure the temperature by knowing the coefficient of thermal expansion. The length of the right arm 804 auxiliary waveguide 160 with respect to the left arm auxiliary waveguide may be defined below, where L_{right} and l_{left} are the nominal lengths of the right and left arms, respectively, and k_{RL} is the ratio between the two:

$${l}_{right} = {k}_{RL} {l}_{left}$$

Given that the phase shift is proportional to length, Δφ_{right} may also be expressed in terms of Δφ_{left} and k_{RL}.

$$Δ {ϕ}_{right} = {k}_{RL} Δ {ϕ}_{left}$$

Using k_{RL} and the measured phase shift of the left arm, the hypothetical phase shift of the right arm auxiliary waveguide may be predicted assuming it had a reflective cap like the left arm, as this is not directly measurable as the impedance of the grain changes the measured phase shift for the right arm auxiliary waveguide.

Based on the previous analysis, the signals received by the radar system are as follows:

$$R {x}_{coupler} = A {Γ}_{coupler} {e}^{j ω t} {e}^{- j Δ {ϕ}_{tx}} {e}^{- j 2 Δ {ϕ}_{common}} {e}^{- j Δ {ϕ}_{rx}}$$

$$R {x}_{left} = A {C}_{left}^{2} {Γ}_{cap} {e}^{j ω t} {e}^{- j Δ {ϕ}_{tx}} {e}^{- j 2 Δ {ϕ}_{common}} {e}^{- j 2 Δ {ϕ}_{left}} {e}^{- j Δ {ϕ}_{rx}}$$

$$R {x}_{right} = A {C}_{right}^{2} {Γ}_{grain} {e}^{j ω t} {e}^{- j {Δϕ}_{tx}} {e}^{- j 2 {Δϕ}_{common}} {e}^{- j 2 {Δϕ}_{right}} {e}^{- j Δ {ϕ}_{rx}}$$

These received signals may also be represented in terms of measured amplitude and phase by:

$$R {x}_{coupler} = {A}_{coupler} {e}^{- j {ϕ}_{coupler}}$$

$$R {x}_{left} = {A}_{left} {e}^{- j {ϕ}_{left}}$$

$${Rx}_{right} = {A}_{right} {e}^{- j {ϕ}_{right}}$$

Dividing Rx_{right} by Rx_{left} gives the following:

$$\frac{R {x}_{right}}{R {x}_{left}} = \frac{A {C}_{right}^{2} {Γ}_{grain} {e}^{j ω t} {e}^{- j Δ {ϕ}_{tx}} {e}^{- j 2 {Δϕ}_{common}} {e}^{- j 2 Δ {ϕ}_{right}} {e}^{- j Δ {ϕ}_{rx}}}{A {C}_{left}^{2} {Γ}_{cap} {e}^{j ω t} {e}^{- j {Δϕ}_{tx}} {e}^{- j 2 Δ {ϕ}_{common}} {e}^{- j 2 Δ {ϕ}_{left}} {e}^{- j Δ {ϕ}_{rx}}}$$

$$\frac{{A}_{right} {e}^{- j {ϕ}_{right}}}{{A}_{left} {e}^{- j {ϕ}_{left}}} = \frac{{C}_{right}^{2} {Γ}_{grain} {e}^{- j 2 {Δϕ}_{right}}}{{C}_{left}^{2} {Γ}_{cap} {e}^{- j 2 {Δϕ}_{left}}}$$

$${Γ}_{grain} = \frac{{A}_{right} {e}^{- j {ϕ}_{right}}}{{A}_{left} {e}^{- j {ϕ}_{left}}} \frac{{C}_{left}^{2} {Γ}_{cap} {e}^{- j 2 {Δϕ}_{left}}}{{C}_{right}^{2} {e}^{- j 2 Δ {ϕ}_{right}}}$$

The phase shift Δφ_{left} may be measured by half the phase difference between φ_{left} and φ_{coupler}, and Δφ_{right} may be measured by this same amount scaled by k_{RL}:

$${Γ}_{grain} = {Γ}_{cap} \frac{{C}_{left}^{2}}{{C}_{right}^{2}} \frac{{A}_{right} {e}^{- j {ϕ}_{right}}}{{A}_{left} {e}^{- j {ϕ}_{left}}} \frac{{e}^{- j ( {ϕ}_{left} - {ϕ}_{coupler} )}}{{e}^{- j {k}_{RL} ( {ϕ}_{left} - {ϕ}_{coupler} )}}$$

$${Γ}_{grain} = {Γ}_{cap} \frac{{C}_{left}^{2}}{{C}_{right}^{2}} \frac{{A}_{right}}{{A}_{left}} \frac{{e}^{- j ( {ϕ}_{right} - {ϕ}_{coupler} )}}{{e}^{- j {k}_{RL} ( {ϕ}_{left} - {ϕ}_{coupler} )}}$$

Once Γ_{grain} has been determined, the complex permittivity may be calculated using the relationship derived earlier:

$$ε = {( \frac{{Γ}_{grain} - 1}{{Γ}_{grain} + 1} )}^{2}$$

Finally, the temperature of the grain is proportional to Δφ_{left}, as the length of the left arm 802 is proportional to temperature due to thermal expansion/contraction.

Once the complex permittivity and temperature have been determined, the moisture and density of the grain sample may be determined from the real and imaginary components, as each of the real and imaginary components are independent functions of moisture, density, and temperature.

Given the output signal given above, the gain through each individual cascaded sensor, G, may be characterized by:

$${G}_{sensor} = {C}_{coupler}$$

If each sensor in the series has the same values for Γ_{coupler}, C_{right}, and C_{left}, n of these sensors cascaded would yield an aggregate gain of:

$${( {G}_{sensor} )}^{n} = {( {C}_{coupler} )}^{\frac{n}{2}}$$

The embodiments described above may also be provided within each grain paddle 110 in a clean grain elevator 300 to perform measurements of temperature as well as moisture and density. In an embodiment of this system, one or more of the cascaded sensors described above may be integrated into a paddle 110 connected via a central waveguide. Each paddle 110 may include a self-contained waveguide apparatus 130, or many paddles 110 may be connected in a cascading fashion via inter-paddle flexible waveguide tubing. The FMCW radar may be aligned to an aperture in the housing of the elevator 300 such that the incident signal is coupled into this central waveguide 130 as the open end of the waveguide 130 passes near the aperture.

Reflected signals produced by each reflector in the system may be separated in frequency to allow spatially diverse temperature and moisture/density measures to be determined within each paddle 110.

In an embodiment, an FMCW chip such as the IWR6843 is placed outside the clean grain elevator housing with the transmit and receive antennas aligned with an aperture in the housing sized to accommodate the pair. For practical reasons, the waveguide opening may be positioned to provide a distance to the FMCW radar antenna pair to avoid physical interference issues. As the waveguide 130 passes by, the angle to the antenna changes continuously; however, the nearly isotropic radiation pattern of the transmit antenna provides coupling over a range of travel. The signal path length changes with angle, and further, because the receive and transmit antennas may not be co-located, the respective angles to the receive and transmit antennas may be different, introducing differences in signal path lengths. However, as measurements are referenced to datum points on the waveguides 130 themselves, the change in total signal path length is immaterial. Similarly, the returning signals radiate nearly isotropically from the open end of the waveguide for robust coupling with the receiving antenna.

FMCW transmit signals include chirps that sweep from low to high frequency. As received signals are demodulated using the transmit chirp as the local oscillator, the time-of-flight delay experienced by a reflection causes the received demodulated signal frequency to be correlated with the object's distance from the radar. Some of the FMCW chirp parameters that may be configured include frequency slope, sweep bandwidth, and the sampling rate of the demodulated signal. Modifications made to these parameters affect performance qualities such as the range resolution, as well as the maximum value of range that may be measured.

For the clean grain elevator monitoring system, the FMCW may be configured for maximum spatial resolution (weight measurement precision), whereas maximum range may be less important as the system's range of measurements may be limited to a relatively short distance from the radar (within the combine harvester). These goals may be achieved by selecting a large sweep bandwidth; for example, for the IWR6843 device, up to 4 GHz bandwidth may be used.

As paddle waveguides 130 move past the radar aperture quickly, the FMCW may be configured for a high chirp repetition rate to provide multiple measurement opportunities over the brief coupling period for redundancy and allowing averaging for improved signal to noise ratio. For the IWR6843, the maximum chirp frequency slope is 250 MHz/us, allowing a sweep of 4 GHz in just 16 us; however, as the maximum recommended duty cycle for this device is 50% using a heat sink, the minimum recommended chirp period is then 32 us.

The analog to digital converter sampling rate may be configured to any value up to a maximum that is supported by the hardware. For the IWR6843, the maximum sampling rate is 25 million samples per second which is divided into two channels for complex signals; one for the in-phase or I channel and the other for the quadrature or Q channel. If N is the number of samples, fₛ is the sampling rate, and T_{chirp} is the duration of the chirp, the number of samples available for a single chirp is equal to:

$$N = {f}_{s} {T}_{chirp}$$

For the case where there is a 16 us chirp duration and a per channel sampling rate of 12.5 MS/s, this would be 200 samples per chirp. However, it is recommended to delay sampling from the start of a chirp to allow the oscillators to settle and the chirp signal stabilizes and terminate before the end of the chirp to prevent any unwanted signal corruption due to the oscillators turning off, reducing the number of available samples per chirp.

If S is the chirp frequency slope, and c is the speed of signal propagation, the maximum range of an FMCW radar system is equal to:

$${d}_{m ax} = \frac{{f}_{s} c}{2 S}$$

The IF frequency associated with this maximum range is as follows:

$${f}_{{IF}_{m ax}} = \frac{S 2 {d}_{m ax}}{c}$$

Depending on the specifics of the hardware, it may be necessary to balance the chirp slope and sampling rate to ensure that the demodulated IF signal is within the receiver's bandwidth.

Given that the FMCW radar-based grain monitoring system may undergo measurement variation due to factors such as temperature due to ambient and operational conditions, distance between the radar and reflector due to machine vibration, and waveguide coupling angle due to paddle-to-radar motion dynamics and related geometry, a stable reference may be used by which phase measurements may be normalized and from which the phase measurements may be referenced. Removing such factors through ratio-metric normalization reveals extra detail via phase measurements, which would otherwise be obscured.

This may be achieved by distributing two sampling reflectors along the waveguide, spaced apart by a distance that may be used as an arbitrary unit of measure, and with which any location along the waveguide may be measured and/or expressed. Multiple locations may be referenced to a common datum, which may be selected as one of the sampling reflector locations for a consistent measurement domain. As systematic and/or environmental factors (as above) may affect all locations proportionally, including those of the reference sampling reflectors and the resultant unit of measure, the measurement domain becomes ratio-metric. For example, uniform thermal expansion of the waveguide affects its size/scale in equal proportion to the ratio-metric unit of measure so that measurements become independent of this expansion.

FMCW radar demodulates received reflected signals to IF frequencies proportional to the objects' respective distances from the radar. If S is the frequency slope of the chirp, c is the speed of light, and d is the distance to the object, the received intermediate frequency (IF) is:

$${f}_{IF} = \frac{S 2 d}{c}$$

Objects that differ in distance produce unique IF frequencies, with farther objects producing higher frequencies. To accurately measure a specific object, its reflection may be isolated from all others. Various techniques that may be used to achieve this are provided below.

In an embodiment, a bandpass filter (BPF) with sufficiently narrow bandwidth and high stop-band attenuation is tuned to the frequency of an IF signal reflected from a reflector to isolate it from other IF frequencies. Similarly, a cosine (or sine) wave tuned to the IF signal frequency of interest may be selected as a basis function with which the IF signal components (I and Q) may be convolved to isolate that reflective feature. The process may result in a plurality of IF reflection signals each isolated using their own BPF.

A Fast Fourier transform (FFT) may be used to produce a complex frequency spectrum of N/2 frequency bins, each of width equal to the sampling frequency divided by N. Increasing the size of the sample set may improve the frequency discrimination, which may be considered as part of the chirp design specification. If the bin width is configured to be sufficiently small, such that each bin includes at most one individual IF reflection signal, then these signals may be separated. The amplitude and phase of each IF signal may then be determined using the complex components of the FFT bin containing it. The complex components (and resultant amplitude and phase values) reflect the correlation of any signals within the bin and a sinusoidal basis function centered on that bin and may differ somewhat from those of the signals themselves. Higher frequency resolution may mitigate this effect.

When complex sampling is used, each signal includes both in-phase (I) and quadrature (Q) components, and each of which may be separated independently using the above techniques, resulting in a pair of orthogonal filtered signals (I_{filtered} and Q_{filtered}) for each reflection.

The amplitude (A) of each filtered complex signal may be determined by the magnitude of each I/Q pair as follows:

$$A = \sqrt{( {I}_{filtered}^{2} + {Q}_{filtered}^{2} )}$$

To determine a signal's precise frequency and phase, a phase line may be generated by determining the phase angle of each filtered sample as follows:

$${ϕ}_{n} = arc tan ( \frac{{Q}_{{filtered}_{n}}}{{I}_{{filtered}_{n}}} )$$

To ensure that the resulting phase line follows a straight-line path, I and Q components may be scaled so that their amplitudes match using techniques that may include comparison of peak-to-peak values (maximum minus minimum) for each component, fitting a sine wave to each component to determine their relative amplitudes, or seeking the scalar that minimizes the residual of a best-fit line model.

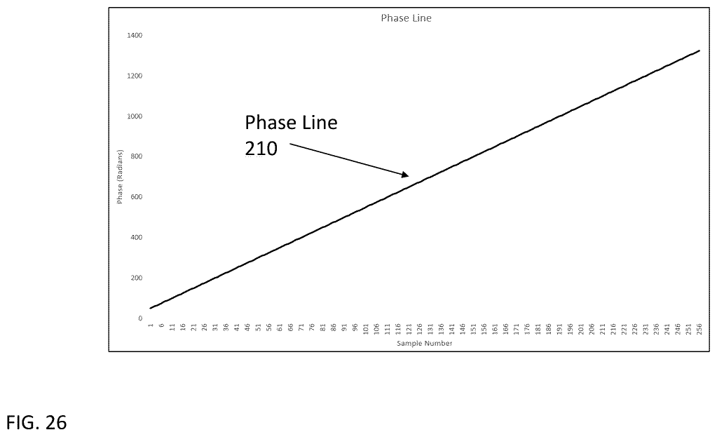

To avoid the angle wrapping around 2π, the phase angle may be corrected by adding 2π as the angle rolls over to 0 radians. The y-intercept of the phase line reflects the initial phase of the reflection, and the frequency by its slope. The resultant phase line may require a linear interpolation/curve fitting as artifacts from the analysis may distort the signals and cause the linearity to be affected. FIG. 26 depicts an example of a phase line 210 of length 256 for an intercept of 45 radians and a frequency of 5 radians/sample.

In one embodiment, two or more reflected signals may be isolated using separate BPFs, each tuned to the respective desired signal frequencies. Subsequently, phase lines may be determined for each isolated signal to accurately reflect its attributes. Using the slope of the line, which corresponds to the signal frequency, the approximate location of the reflector may be determined. Smaller deviations in location may be determined using the y intercept, which corresponds to the phase of the IF signal.

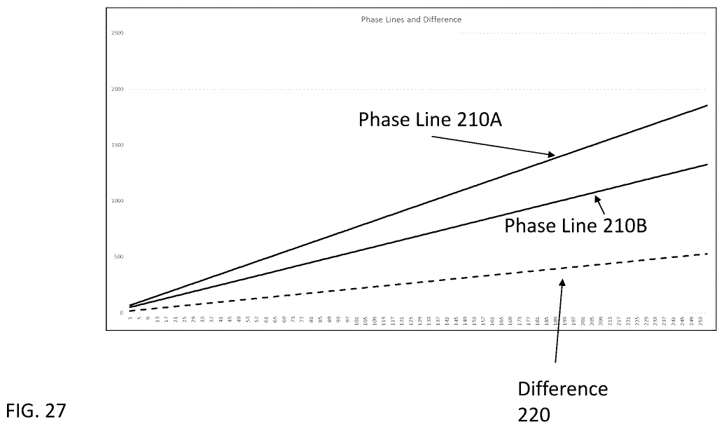

If two signals are demodulated to two different IF frequencies, two phases are received, an example of which is provided in FIG. 27. The difference between the two-phase lines 210A and 210B is shown as a dashed line 220. The signals are of frequencies 5 and 7 radians per sample with y-intercepts of 45 and 60 radians respectively.

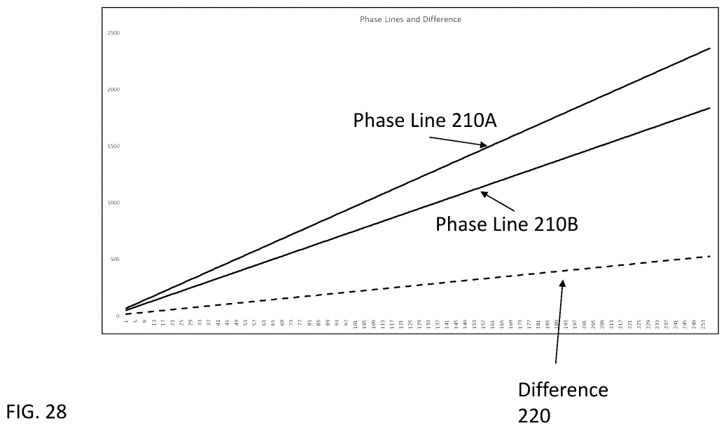

If the two frequencies are increased by a constant value (both reflectors are moved the same distance from the radar), the difference remains constant, as the difference signal eliminates common mode IF frequency (reflector distance) offsets common to each signal. In FIG. 28, the signals are of frequencies 7 and 9 radians per sample (a common increase of 2 radians per sample) with the same y-intercepts of 45 and 60 radians respectively.

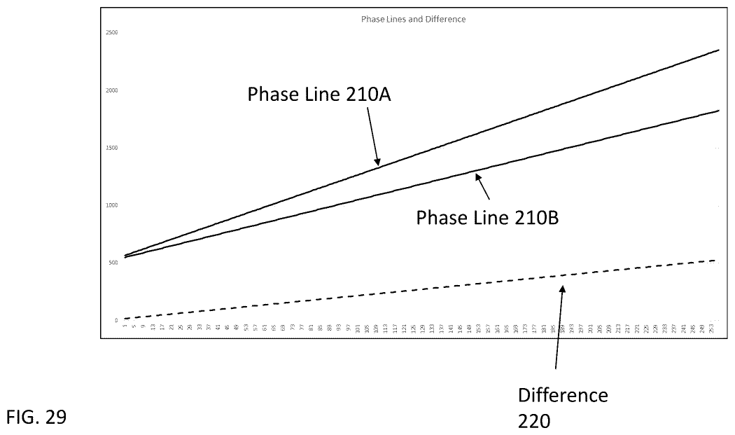

Similarly, common phase offsets that affect each signal equally also do not alter the difference signal. In FIG. 29, the y-intercept values are each increased by 500 radians to 545 and 560 radians, respectively, while leaving the original frequency values at 5 and 7 radians per sample.

As discussed previously, the weight of a paddle and payload is determined by measuring the deflection of the double bending beam 140, which may be monitored using FMCW radar as the phase of reflections from the beam's bending surface(s). Measurements may be single ended (using a single deflection measurement) or differential (using a measurement from either side of the bending beam 140). Differential measurements may be helpful in suppression of common-mode noise (such as thermal expansion, vibration, etc.) and drift in the transmit and receive signal chains. To further reduce the impacts of thermal expansion, machine vibration, and motion dynamics, phase measurements may be made ratio-metric with respect to a reference scale and datum location including two sampling reflectors spaced apart.

When a chirp signal is received, it is demodulated such that the IF frequency content includes components that correspond to the round-trip distance to objects that provide reflections. To determine the amplitude and phase of each reflected signal, the signals must be isolated/separated from each other using filters, FFT, or similar techniques. To determine the required filter characteristics needed to isolate the signal, the frequency of the reflected signal must be determined, either by analysis of the demodulated IF signal peaks, or by knowledge of the distance from the radar and speed of propagation. Once determined, the frequency may then be used to tune the center frequency of a bandpass or other frequency selective filter or determine which FFT bin contains the amplitude and phase information being sought.

When using bandpass filters to separate signals, the center frequency of a filter may be tuned to the frequency of interest and the bandwidth would be designed to pass the signal of interest while suppressing the others through sufficient attenuation.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the described embodiments should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

1. A system for determining yield data for a grain operation, the system comprising:
a Frequency-Modulated Continuous Wave (FMCW) radar system configured to generate and transmit a signal; and
one or more components of a clean grain elevator configured to carry a load;
wherein the FMCW radar system is configured to measure a distance from the FMCW radar system to the one or more components using the signal, wherein the distance to the one or more components varies with a weight of the load carried or handled by the one or more components.

2. The system of claim 1, wherein the FMCW radar system is located on an exterior of the clean grain elevator, wherein the one or more components are located in an interior of the clean grain elevator.

3. The system of claim 2, further comprising:
one or more waveguides configured to guide the signal from the FMCW radar system to the one or more components.

4. The system of claim 3, wherein the one or more waveguides are sealed to prevent dust or debris from infiltration.

5. The system of claim 1, wherein the one or more components comprise a beam of a paddle of a moving paddle chain of the clean grain elevator.

6. The system of claim 5, wherein the paddle is supported by the beam that deflects when a weight of the load is applied to the paddle, wherein after the paddle of the moving paddle chain arrives at a coupling location, the transmitted signal couples into a waveguide and travels to a point along a length of the waveguide where the transmitted signal radiates through an aperture aimed down toward a surface of the beam, wherein the transmitted signal reflects off the surface of the beam, re-enters the aperture of the waveguide, and the reflected signal returns to the FMCW radar system through the waveguide.

7. The system of claim 6, wherein the transmitted signal reflects off an upper surface of the beam.

8. The system of claim 1, wherein the FMCW radar system is configured to measure the distance based on a frequency or phase of the signal reflected off a surface of the one or more components.

9. The system of claim 1, wherein the FMCW radar system is further configured to determine a moisture content of the load by measuring an attenuation and phase shift of the signal reflected off of the load.

10. The system of claim 1, wherein the FMCW radar system is further configured to determine a temperature of the load by measuring an amount of a thermal expansion or contraction of a known length of a waveguide used to guide the signal through the load.

11. The system of claim 1, wherein the FMCW radar system is further configured to determine a torque and rotational speed of a shaft of the clean grain elevator using signals reflected off two or more components of the shaft.

12. The system of claim 11, wherein the two or more components of the shaft each include a waveguide positioned above each component of the two or more components that is used to measure a phase of a reflected signals off a respective component, wherein the two or more components include a weakened portion of the shaft between them or may be spread apart such that there is enough twist in the shaft as result of an applied torque to cause a relative rotation between the two or more components.

13. A method for determining yield data for a grain operation, the method comprising:
generating and transmitting, by a Frequency-Modulated Continuous Wave (FMCW) radar system, a signal;
coupling the signal into a waveguide affixed to a paddle attached to a moving paddle chain;
reflecting the signal off a surface attached to the paddle, wherein a distance from the FMCW radar system to the surface varied depending on a weight of a load carried by the paddle; and
determining, by the FMCW radar system, the weight of the load carried by the paddle using a frequency or a phase of the reflected signal.

14. The method of claim 13, wherein the paddle is supported by a beam that deflects when weight is applied to the paddle, wherein after the paddle arrives at a coupling location, the transmitted signal couples into the waveguide and travels to a point along a length of the waveguide where the transmitted signal radiates through an aperture aimed down toward a surface of the beam, wherein the transmitted signal reflects off the beam's surface, re-enters the aperture of the waveguide, and the reflected signal returns to the FMCW radar system through the waveguide.

15. The method of claim 13, further comprising:
determining, by the FMCW radar system, a moisture content of the load by measuring an attenuation and phase shift of the coupled signal reflected off the load.

16. The method of claim 13, further comprising:
determining, by the FMCW radar system, a density of the load by measuring an attenuation and phase shift of the coupled signal reflected off the load.

17. The method of claim 13, further comprising:
determining, by the FMCW radar system, a temperature of the load by measuring an amount of a thermal expansion or contraction of a known length of a waveguide that guides the signal through the load.

18. A waveguide system for determining yield data for a grain operation, the waveguide system comprising:
a single main waveguide tube comprising one or more auxiliary waveguide tap points that are configured to guide a signal from a Frequency-Modulated Continuous Wave (FMCW) radar system to one or more components of a clean grain elevator and return a reflected signal to the FMCW radar system that is configured to determine one or more data points for grain carried by the clean grain elevator.

19. The waveguide system of claim 18, wherein at least one auxiliary waveguide tap point of the one or more auxiliary waveguide tap points leads to a waveguide surrounded by the grain, wherein the FMCW radar system is configured to determine a temperature of the grain by measuring an amount of a thermal expansion or contraction of a known length of the waveguide surrounded by the grain.

20. The waveguide system of claim 19, wherein at least one auxiliary waveguide tap point of the one or more auxiliary waveguide tap points guides the signal to the grain on the paddle, wherein the FMCW radar system is configured to determine a moisture content of the grain by measuring an attenuation and phase shift of the signal reflected off the grain.
